(19) United States
(12) Patent Application Publication
(10) Pub. No.: US 2002/0135807 A1
(43) Pub. Date: Sep. 26, 2002

(54) Status notification system, its device and method for notifying status information to portable terminal

(76) Inventor: Takenori Idehara, Tokyo (JP)

Correspondence Address: Barry E. Bretschneider, Morrison & Foerster LLP, Suite 5500, 2000 Pennsylvania Avenue, N.W., Washington, DC, 20006-1888, US

(21) Appl. No.: 10/102,880

(22) Filed: Mar. 22, 2002

(30) Foreign Application Priority Data
Mar. 22, 2001 (JP) 2001-082817

(51) Int. Cl. G06F 15/00; B41J 1/00

(52) U.S. Cl. 358/1.15

(57) ABSTRACT

The status notification system has a potable terminal and multiple devices including a device for executing a job. At least one of these multiple devices is equipped with a short-distance communication unit for conducting short-distance communication with the portable terminal. The job-executing device is equipped with a detector for detecting a device, which is capable of short-distance communication with the portable terminal, and transfers status information concerning the job-executing device's status to the detected device in case the detected device is not the job-executing device. The device detected by the detector transmits the status information to the portable terminal via the short-distance communication unit.

This application is based on Japanese Patent Application No. 2001-82817 filed on Mar. 22, 2001, the contents of which are hereby incorporated by reference.

### BACKGROUND OF THE INVENTION

1. Field of the Invention

The present invention relates to a status notification system, its device and method for notifying a portable terminal of information concerning job-processing status.

2. Description of Related Art

Various systems have been known for displaying information concerning printing job status, for example, displaying status information on the screen of a printer that executes a printing job, or on the screen of a computer that transmits a printing job to a printer. Such a system can thus provide the user status information such as completion of a printing job or paper jam.

However, in a system in which status information is displayed on the screen of a printer or a computer, it is impossible for a user who is away from the computer or the printer to receive any status information notification. Thus, such a user cannot be advised of any incidents such as completion of a printing job or paper jam.

Various systems have been proposed in recent years that enable to notify a portable telephone carried by a user of status information via e-mail by means of connecting a network such as a LAN, to which computers and printers are connected, to an existing portable telephone network.

However, it poses burdens of communication fees to users if status information is transmitted through an existing mobile telephone network. Moreover, it takes a long time for a user before receiving status information after an incident such as completion of a printing job or paper jam occurs, thus causing the user a delay in responding to the incident. This is due to the fact that it takes a long time for processing the connection between mobile telephone network and the network to which computers and printers are connected, and/or that it takes a long time for the e-mail server to handle the process.

The abovementioned problem associated with notifying status information occurs not only with network systems consisting of computers and printers, but also with network systems where various devices such as personal computers, digital copying machines, printers, facsimiles, and scanners are interconnected.

### SUMMARY OF THE INVENTIONS

It is an intention of the present invention to provide a status notification system capable of quickly notifying users of status information concerning job-processing status even when the users are not located close to execution devices for executing jobs or transmission devices for transmitting jobs.

It is another intention of the present invention to provide a status notification system capable of inexpensively and quickly to portable terminals carried by users.

According to an aspect of the present invention, a status information notifying system has a portable terminal and a job execution device for executing a job. The job execution device is equipped with a detector for detecting a device that is capable of short-distance communication with the portable terminal. The portable terminal receives status information concerning the job execution device's job processing status via the device detected by the detector.

According to another aspect of the present invention, a status notification system has a potable terminal and multiple devices including a device for executing a job. At least one of these multiple devices is equipped with a short-distance communication unit for conducting short-distance communication with the portable terminal. The job-executing device is equipped with a detector for detecting a device, which is capable of short-distance communication with the portable terminal, and transfers status information concerning the job-executing device's status to the detected device in case the detected device is not the job-executing device. The device detected by the detector transmits the status information to the portable terminal via the short-distance communication unit.

### BRIEF DESCRIPTION OF THE DRAWINGS

FIG. 1 is a block diagram showing an example constitution of a status notification system corresponding the first embodiment;

FIG. 2 is a block diagram showing an example constitution of the personal computer shown in FIG. 1;

FIG. 3 is a block diagram showing an example constitution of a digital copying machine equipped with a local interface used in the system shown in FIG. 1;

FIG. 4 is a block diagram showing an example constitution of a digital copying machine unequipped with a local interface used in the system shown in FIG. 1;

FIG. 5 is a block diagram showing an example constitution of a printer equipped with a local interface used in the system shown in FIG. 1;

FIG. 6 is a block diagram showing an example constitution of a printer unequipped with a local interface used in the system shown in FIG. 1;

FIG. 7 is a block diagram showing an example constitution of a facsimile machine equipped with a local interface used in the system shown in FIG. 1;

FIG. 8 is a block diagram showing an example constitution of a facsimile machine unequipped with a local interface used in the system shown in FIG. 1;

FIG. 9 is a block diagram showing an example constitution of a scanner equipped with a local interface used in the system shown in FIG. 1;

FIG. 10 is a block diagram showing an example constitution of a scanner unequipped with a local interface used in the system shown in FIG. 1;

FIG. 11 is a block diagram showing an example constitution of a portable phone, which is an example of the portable terminals used in the system shown in FIG. 1;

FIG. 12 is a block diagram showing an example constitution of a portable terminals used in the system shown in FIG. 1;

FIG. 13 is a flowchart showing the process of a printing request by the personal computer shown in FIG. 2;

FIG. 14 is a flowchart showing a subroutine of the. process of designating a notification target shown in FIG. 13;

FIG. 15 shows an example printing setup screen in the personal computer shown in FIG. 2;

FIG. 16 shows an example screen for designating a status notification target in the personal computer shown in FIG. 2;

FIG. 17 shows an example of notification target information prepared by the personal computer shown in FIG. 2;

FIG. 18 shows another example of notification target information prepared by the personal computer shown in FIG. 2;

FIG. 19A and FIG. 19B are flowcharts showing the status notification operation of the digital copying machine shown in FIG. 3;

FIG. 20 is a flowchart showing a subroutine of the process of detecting a notification target in FIG. 19B;

FIG. 21 is a flowchart showing a subroutine of the process of detecting another device shown in FIG. 19B;

FIG. 22 is a flowchart for describing the operation of a device different from the digital copying machine, specifically, of the printer shown in FIG. 5;

FIG. 23A and FIG. 23B are flowcharts showing a status notification operation for the user of the portable telephone shown in FIG. 11;

FIG. 24 shows an example operation sequence of the status notification system shown in FIG. 1;

FIG. 25 is a diagram for describing the first modification example of the first embodiment, specifically a flowchart showing a modification example of the process of detecting another device shown in FIG. 19B;

FIG. 26 is a diagram showing an example data contained in the request for detecting a notification target in the first modification example shown in FIG. 25;

FIG. 27A and FIG. 27B are flowcharts showing an operation of a device different from the digital copying machine in the first modification example shown in FIG. 25;

FIG. 28 is a diagram for describing the third modification example of the first embodiment, more specifically, a block diagram showing a modified constitution for the personal computer shown in FIG. 1;

FIG. 29A and FIG. 29B are flowcharts showing the notification designation operation of the computer shown in FIG. 28;

FIG. 30 is a diagram showing an example table of notifiable targets used in designating notification target designation operation shown in FIG. 29A and FIG. 29B;

FIG. 31 is a diagram showing an example display screen of the list of notifiable targets prepared based on the table of notifiable targets shown in FIG. 30;

FIG. 32 is a block diagram showing an example constitution of a status notification system related to the second embodiment of the present invention;

FIG. 33A and FIG. 33B are flowcharts showing operations of digital copying machines used in the system shown in FIG. 32;

FIG. 34 is an example block diagram showing an example constitution of a status notification system concerning the third embodiment of the present invention;

FIG. 35 is a flowchart showing the process of a printing request by a personal computer used in the system shown in FIG. 34;

FIG. 36 is a flowchart showing a printing operation of a digital copying machine used in the system used in FIG. 34; and

FIG. 37A and FIG. 37B are flowcharts showing the status notification operation of a personal computer used in the system shown in FIG. 34.

### DESCRIPTION OF THE PREFERRED EMBODIMENTS

Preferred embodiments of the present invention will be described below referring to the accompanying drawings.

### First Embodiment

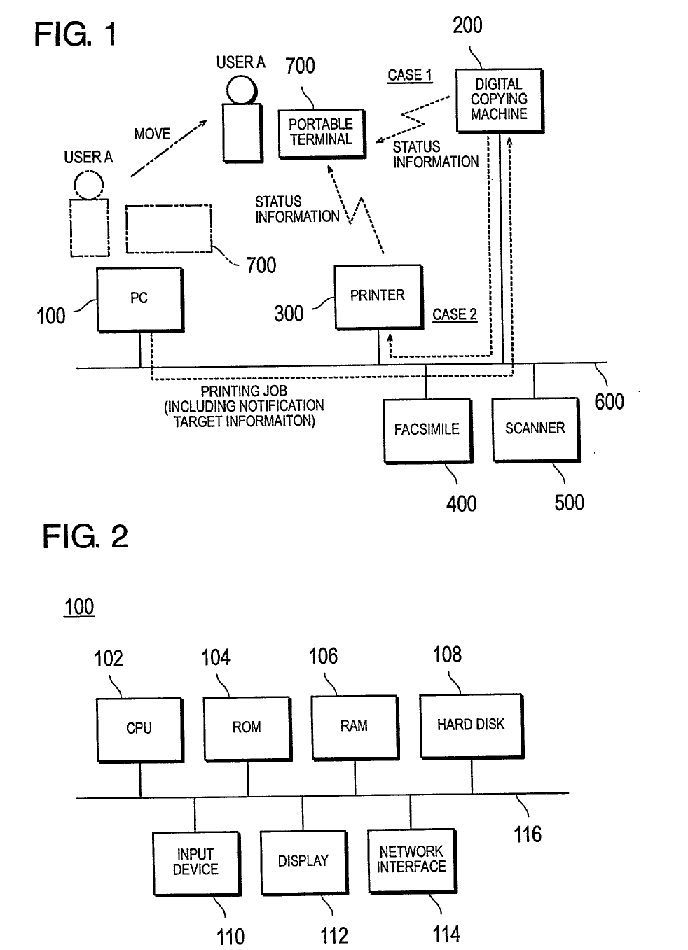

FIG. 1 is a block diagram showing an example constitution of a status notification system corresponding the first embodiment of the present invention. The network system includes multiple devices. These multiple devices include a personal computer (“PC”) 100, a digital copying machine 200, a printer 300, a facsimile 400, and a scanner 500. These devices are interconnected via a network 600. The network 600 is, for example, a LAN, such as Ethernet®, TokenRing, and FDDI (fiber distributed data interface). However, the network 600 can be a WAN consisting of multiple LANs connected with each other, or other kinds of networks. The kinds and the number of devices that can be connected to the network 600 are not limited to examples shown in FIG. 1.

A user A uses the PC 100. The user A also owns a portable terminal 700. The portable terminal can be a portable telephone, a PHS (trademark), a PDA, a notebook PC, a pager, an electronic notebook, etc.

The portable terminal 700 is capable of short-distance communication with specified devices connected to the network 600 at a short distance. A short-distance communication herein means a communication conducted within a short distance without recourse to the network 600. Short-distance communications include both wireless short-distance communications and wired short-distance communications. Typically, short-distance communications are communications within 100 meters, and more preferably, local communications within 10 meters. It is preferable that short-distance communications conform to standards such as Bluetooth® IEEE 802.11, Home RF, and IrDA.

Next, the constitution of each of the aforementioned devices will be described. In order to avoid redundancy, those functions that are common to various devices will be described only once when they first appear, and will be omitted from the second time on.

FIG. 2 is a block diagram showing an example constitution of the PC 100 shown in FIG. 1. The PC 100 is equipped with a CPU 102, a ROM 104, a RAM 106, a hard disk 108, an input device 110, a display unit 112, a network interface 114, and a bus 116.

The CPU 102 is in charge of various control and operation processes. The ROM 104 stores programs. The RAM 106 temporarily stores data serving as a working area. The hard disk 108 stores programs and data. The input device 110 is a device including a keyboard, a mouse, etc., used for entering various input data. The display unit 112 displays various items. The network interface 114 connects the PC 100 to the network 600 so that it can perform various communications with other devices. The bus 116 is used for exchanging signals between various units mentioned above.

The hard disk 108 for example has word processing software installed as a piece of application software. However, the hard disk 108 can have other types of software installed. Moreover, the hard disk 108 has such items as printer drivers installed. Printer drivers are software for controlling image forming devices such as the digital copying machine 200 and the printer 200.

The PC 100 sets up desired printing conditions from the printing functions built into the devices such as the printer 300 using the printer drivers. The printing condition to be set up include, for example, paper size, number of copies to be printed, scaling factor, density, single/double sided printing, sorting/non-sorting, etc. The printer driver prepares, i.e., issues a printing job based on the printing condition being set up. The prepared printing job is transmitted from the PC 100 via the network 600 to a job execution device such as the digital copying machine 200 and the printer 300. Therefore, the PC 100 functions as a job transmission device for transmitting printing jobs.

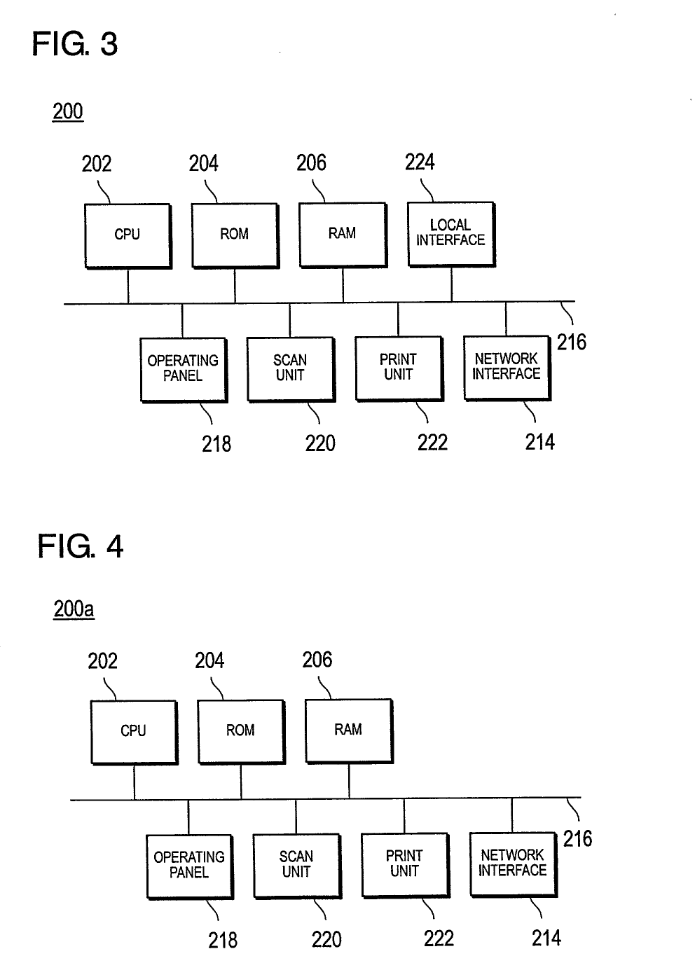

FIG. 3 is a block diagram showing an example constitution of the digital copying machine 200 shown in FIG. 1. The digital copying machine 200 is equipped with a CPU 202, a ROM 204, a RAM 206, an operating panel 218, a scan unit 220, a print unit 222, a network interface 214, a local interface 224, and a bus 216.

The operating panel 218 allows the operator to enter inputs and displays various data. The operating panel 218 includes a touch panel, fixed keys, indicator lamps, etc. The scan unit 220 obtains image data by scanning documents that are to be copied. The print unit 222 executes printing jobs to print on paper.

The local interface 224 is an interface for short-distance communications, and functions as a short-distance communication unit. The local interface 224 is preferably an interface of a wireless communication type capable of communicating within only 10 meters. The local interface 107 preferably conforms to the Bluetooth® standard designed to transmit data at frequencies higher than 2 GHz from the standpoint of high speed data transmissions and also from the standpoint of solving problems due to the directionality of lights that might occur when IrDA is used. The digital copying machine 200 is connected to the network 600. The digital copying machine 200 has a capability as a printer for executing printing jobs received from other devices such as PC 100 in addition to the function as an ordinary copying machine.

It is not necessary for all digital copying machines to have the local interface 224 in this embodiment. In other words, the devices connected to the network 600 may include a digital copying machine that does not have the local interface 224 and hence lacks the capability of short-distance communication with the portable terminal 700. The constitution of a digital copying machine 200a that is not equipped with the local interface 224 is as shown in FIG. 4.

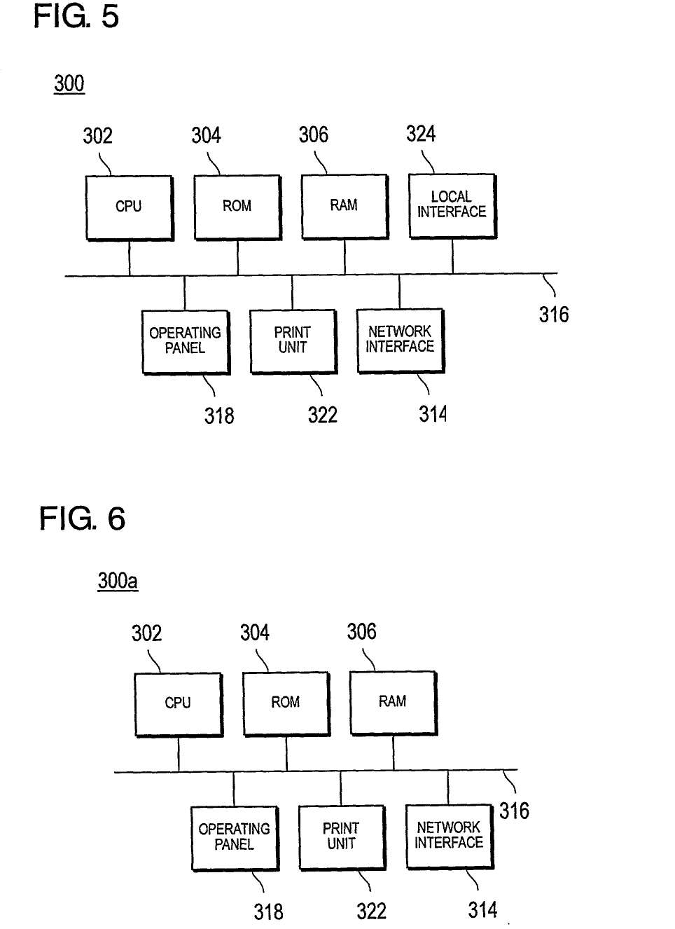

FIG. 5 is a block diagram showing an example constitution of the printer 300. The printer 300 is equipped with a CPU 302, a ROM 304, a RAM 306, an operating panel 318, a print unit 322, a network interface 314, a local interface 324, and a bus 316. The printer 300 executes printing jobs received from devices the PC 100 or the other device via the network 600 to print on paper.

It is not necessary for all printers to have the local interface 324 in this embodiment. The constitution of a printer 300a that is not equipped with the local interface 324 is as shown in FIG. 6.

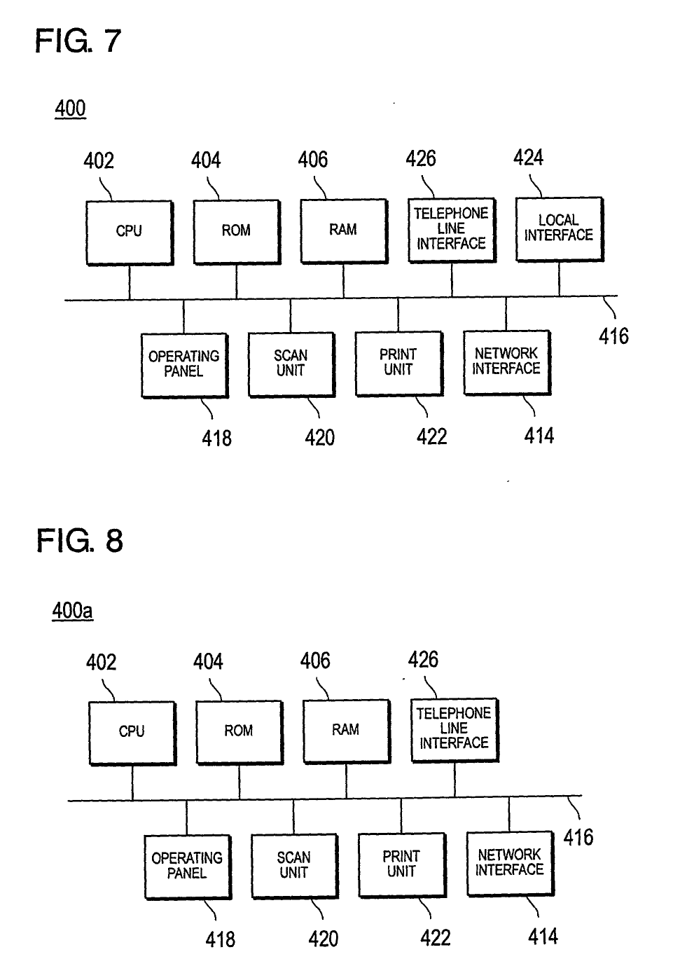

FIG. 7 is a block diagram showing an example constitution of the facsimile machine 400. The facsimile machine 400 is equipped with a CPU 402, a ROM 404, a RAM 406, an operating panel 418, a scan unit 420, a print unit 422, a network interface 414, a local interface 424, a telephone line interface 426, and a bus 416.

The scan unit 420 obtains image data by scanning documents that need to be sent by facsimile transmission. The print unit 422 prints based on image data received. The telephone line interface 426 is an interface for connecting the facsimile machine 400 to the telephone line.

The facsimile machine 400 is connected to the network 600. Therefore, the facsimile 400 may have a function as a printer for executing printing jobs received from other devices such as the PC 100 via the network 600.

It is not necessary for all facsimile machines to have the local interface 424 in this embodiment. The constitution of a facsimile machine 400a that is not equipped with the local interface is as shown in FIG. 8.

FIG. 9 is a block diagram showing an example constitution of the scanner 500. The scanner 500 is equipped with a CPU 502, a ROM 504, a RAM 506, an operating panel 518, a scan unit 520, a network interface 514, a local interface 524, and a bus 516. The scan unit 520 obtains image data by scanning documents.

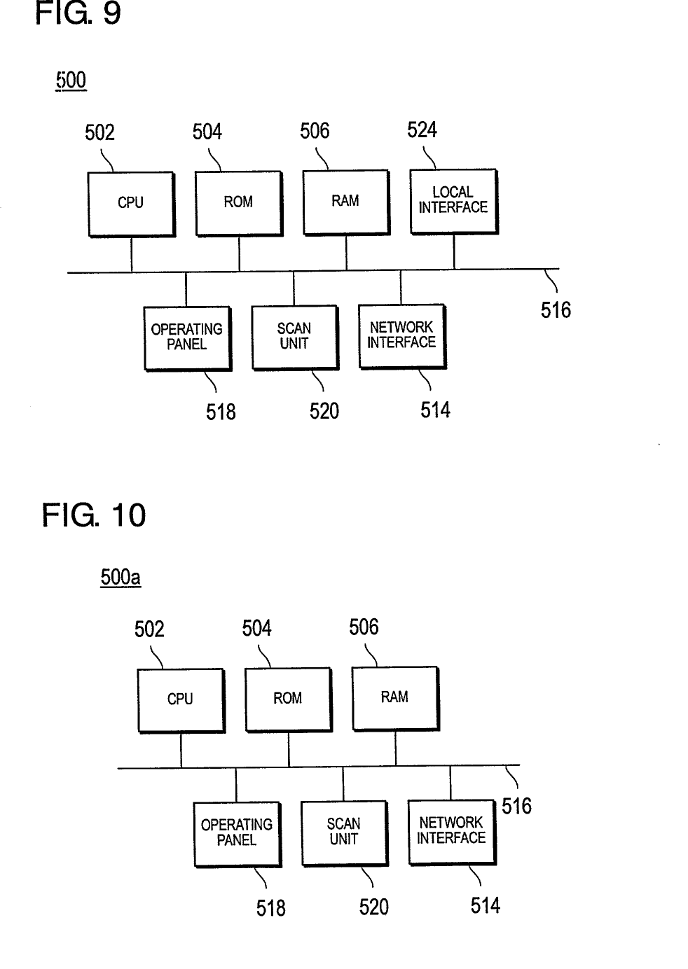

It is not necessary for all scanners to have the local interface 524 in this embodiment. The constitution of a scanner 500a that is not equipped with the local interface is as shown in FIG. 10.

As can be seen from the above, the PC 100 functions as a transmission device for transmitting jobs. Various devices such as the digital copying machine 200, the printer 300, the facsimile 400, and the scanner 500 function as job execution devices for executing various jobs such as printing jobs, copying jobs, facsimile jobs, and scanning jobs. Especially, the digital copying machine 200, the printer 300, and the facsimile 400 function as job execution devices equipped with a print unit.

On the other hand, in a system which transmits image data obtained by scanning documents by the scanner 500 to the printer 300 as printing jobs, the scanner 500 functions as a job transmission device as well. Similarly, there are cases where in the digital copying machine 200 and the facsimile machine 400 function as job transmission devices. Multiple devices are connected to the network 600 in this embodiment and at least one job execution device such as the printer 300 is included in those devices. Moreover, devices equipped with the local interface (i.e., short-distance communication unit) such as shown in FIG. 3, FIG. 5, FIG. 7, and FIG. 9 are included in those devices.

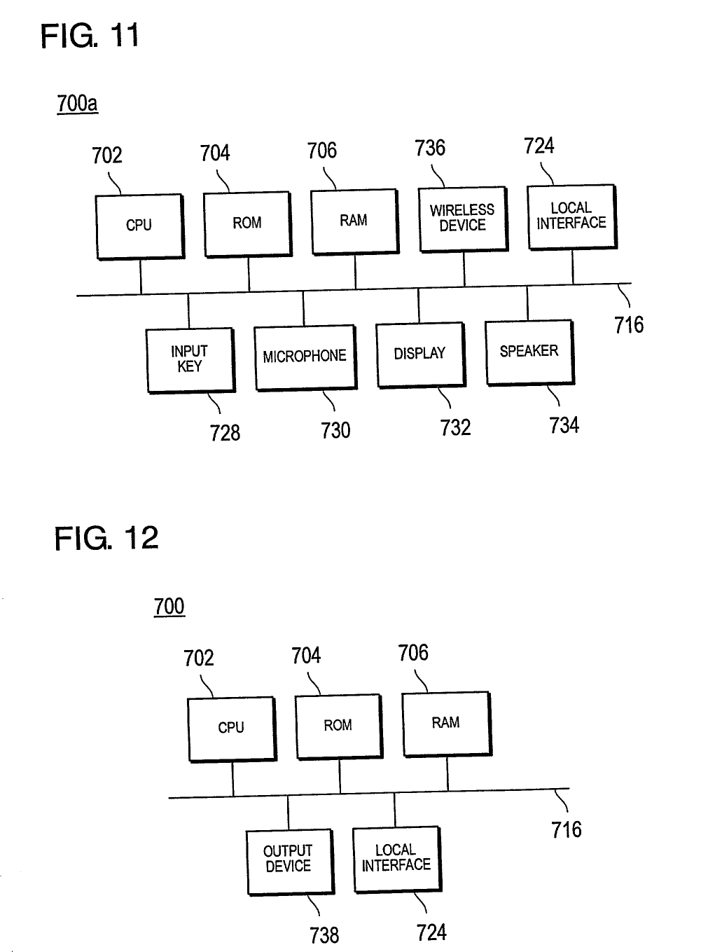

FIG. 11 is a block diagram showing an example of the portable terminal 700, or more specifically, the block diagram of a portable telephone 700a. The constitution of PHS® is basically similar to that of the portable telephone 700a.

In FIG. 11, the portable telephone 700a is equipped with a CPU 702, a ROM 704, a RAM 706, input keys 728, a microphone 730, a display 732, a speaker 734, a local interface 724, a wireless device 736, and a bus 716.

The input keys 728 are used for entering various inputs. The microphone 730 is used for voice inputs. The display 732 is used for displaying information. The speaker 734 is used for voice outputs. The wireless device 736 is used for transmitting and receiving various signals from the outside via a mobile telephone network (more generally a mobile communication network) using radio waves of a specified frequency band. The local interface 724 is an interface for executing short-distance communications with local interfaces 224, 324, 424, and 524 of each of the above mentioned devices.

In case of a portable terminal that lacks a wireless communication function via a mobile communication network, the wireless device 736 is not needed. The components of a portable terminal 700 lacking the wireless device 726 are as shown in FIG. 12. In other words, the portable terminal 700 is equipped with a CPU 702, a ROM 704, a RAM 706, a local interface 724, an output device 738, and a bus 716.

The output device 738 notifies the user of the status information. The output device 738 is more specifically a display unit 732 and/or a speaker 734 that emits status information as voice output. The status information here means information concerning the status, in particular, information concerning the job processing status, of a job execution device (for example, the digital copying machine 200).

In this embodiment, a device executing a job, for example, the digital copying machine 200, detects a device that is capable of short-distance communications with a designated portable terminal 700, for example the printer 300, from multiple devices connected to the network. In other words, a device, which has a capability of short-distance communications with a designated portable terminal 700, and also which is in a condition of conducting short-distance communications with the designated portable terminal 700, is detected from multiple devices. The device for executing the job transmits the status information to the detected device via the network 600. The detected device transmits the status information to the portable terminal 700 via the local interface designed for short-distance communications. In this embodiment, the portable terminal 700 is designated in advance by the PC 100 that transmits the job.

Specific examples of the status information corresponding to various kinds of job execution devices are as follows. When the job execution device is the digital copying machine 200, the status information include, for example, document reading status, printing status, printing completion, emptiness of consumable items such as paper and toner, and error information such as paper jam. If the job execution device is the printer 300, the status information includes printing status, printing completion, emptiness of consumable items such as paper and toner, and error information such as paper jam. If the job execution device is the facsimile 400, the status information includes document reading status, transmission status, transmission completion, transmission error, emptiness of consumable items such as paper and toner, paper jam, receiving status, printing status, and receiving errors. If the job execution device is the scanner 500, the status information includes, for example, document reading status, and data transmission status over the network 600. Let us now describe the operation of the status notification system related to this embodiment, using a case a case where a printing job is received by the digital copying machine 200 from the PC 100 as shown in FIG. 1, and the portable terminal 700 is to be notified of the information concerning the process status of the printing job being executed by the digital copying machine 200.

<Process on the PC as a Job Transmission Device>

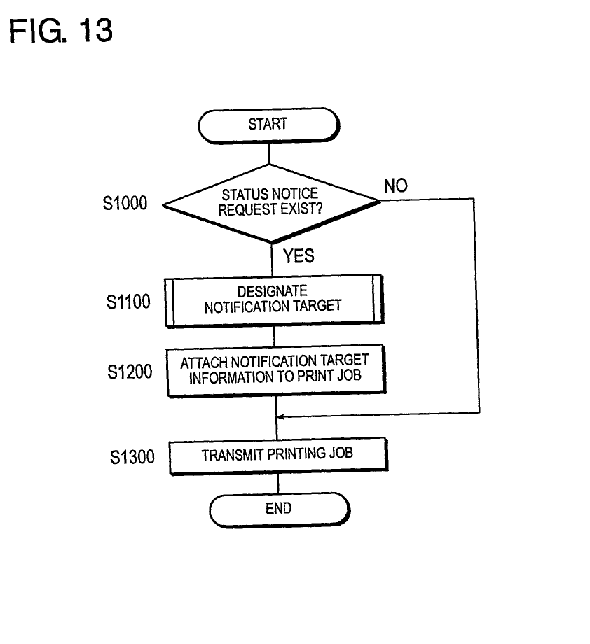

FIG. 13 is a flowchart showing the process of a printing request by the PC 100 addressed to the digital copying machine 200. The process shown in the flowchart of FIG. 13 is stored in the ROM 104 or the hard disk 108 of the PC 100 as a control program and this control program is executable by the CPU 102.

A judgment is made in the step S1000 whether the status notification request exists. The status notification request mentioned here means an instruction for setting up the process of notifying the designated portable terminal of the status information. The judgment on whether the status notification request exists is made based on whether the specific input operation is made by the user A to the input device 110. If there is a status notification request (S1000: Yes), the process advances to the step S1100. If there is no status notification request (S1000: No), the process immediately proceeds to the step S1300.

In the step S1100, a status-information receiving portable terminal 700 (“notification target”) is designated. For example, the user A's portable telephone 700a is designated.

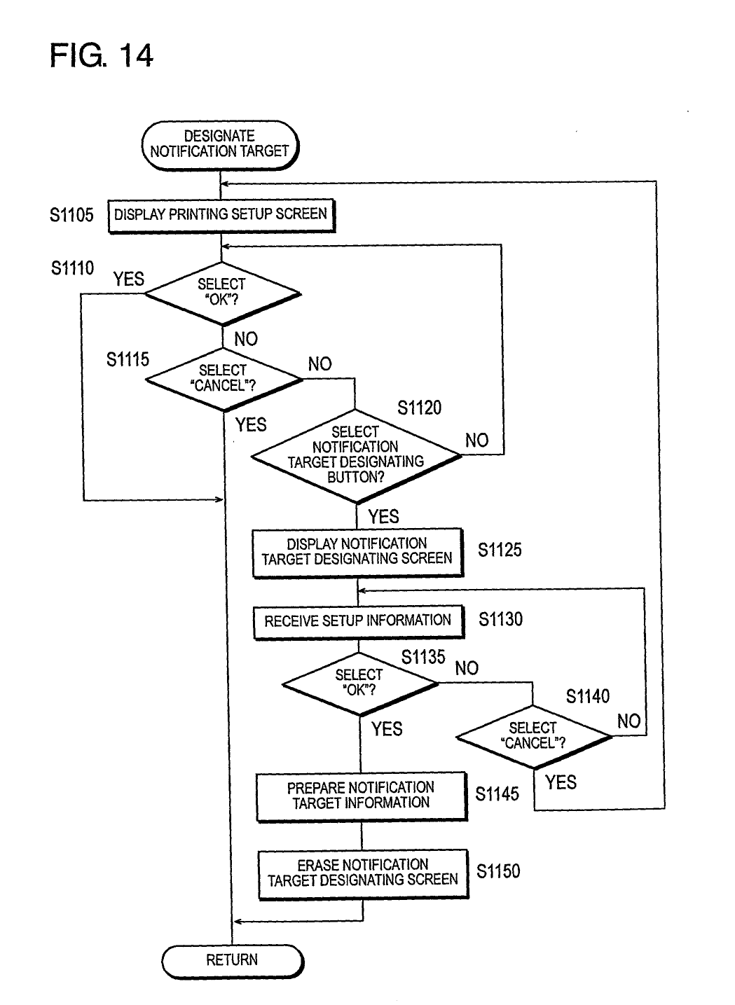

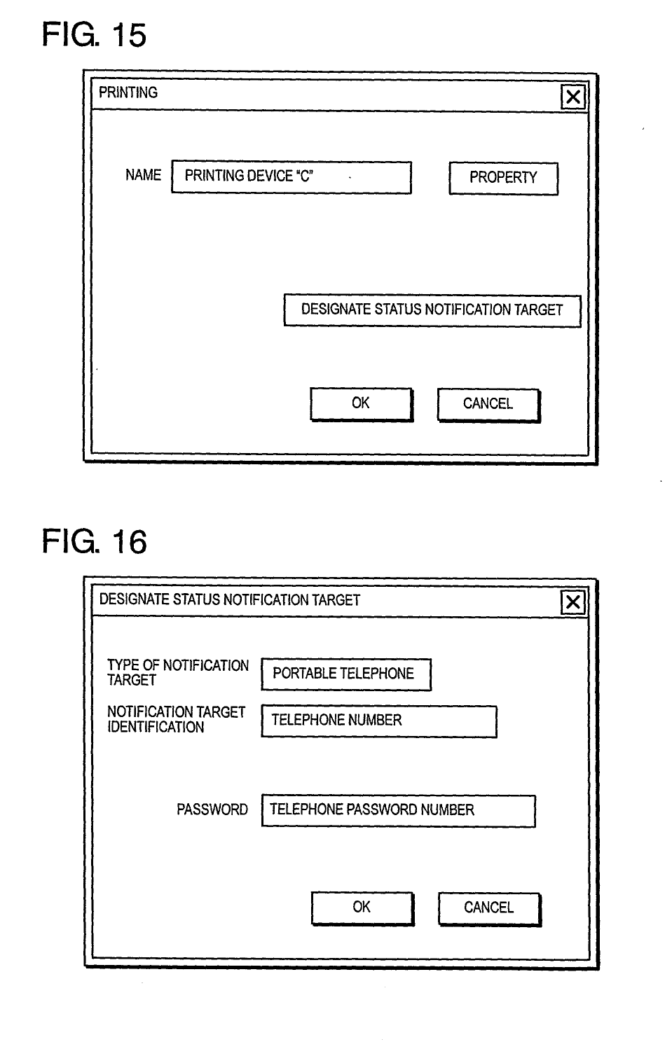

The designation process content of the step S1100 is as shown in FIG. 14. In the step S1105 shown in FIG. 14, the printing setup screen for setting up the printing conditions is displayed on the display unit 112. An example of the printing setup screen is shown in FIG. 15.

In the step S1110, a judgment is made as to whether the “OK” portion of the printing setup screen is clicked. If the “OK” portion is clicked (S1110: Yes), the process immediately proceeds to the main flowchart shown in FIG. 13. If “OK” portion is not clicked (S110: No), the process advances to the step S1115.

A judgment is made in the step S1115 whether the “Cancel” portion of the printing setup screen is clicked. If the “Cancel” portion is clicked (S1115: Yes), the process immediately proceeds to the main flowchart shown in FIG. 13. If “Cancel” portion is not clicked (S1115: No), the process advances to the step S1120.

A judgment is made in the step S1120 whether the notification target-designating button is clicked. The notification target-designating button on the printing setup screen shown in FIG. 15 mentioned here is the portion where it says, “Designate the status notification.” If the “notification target-designating button” is clicked (S1120: Yes), the process immediately proceeds to the step S1125. If the “notification target-designating button” is not clicked (S1120: No), the process returns to the step S1110. In the step S1125, the screen of the display unit 1112 is switched to the status notification-designating screen. An example of the status notification-designating screen is as shown in FIG. 16.

In the step S1130, the information set up by the user A on the status notification-designating screen is acquired. The information contains the type of notification target, the identification method, and the password in case of FIG. 16. The password is used for verification. However, it goes without saying that the information set up by the user A is not limited to the case shown in FIG. 16.

In the step S1135, a judgment is made as to whether the “OK” portion of the status notification-designating screen is clicked. If the “OK” portion of the status notification-designating screen is clicked (S1135: Yes), the process advances to the step S1145. If the “OK” portion of the status notification-designating screen is not clicked (S1135: No), the process advances to the step S1140.

In the step S1140, a judgment is made as to whether the “Cancel” portion of the status notification-designating screen is clicked. If the “Cancel” portion of the status notification-designating screen is clicked (S1140: Yes), the process immediately advances to the step S1150. If the “Cancel” portion of the status notification-designating screen is not clicked (S1140: No), the process returns to the step S1130.

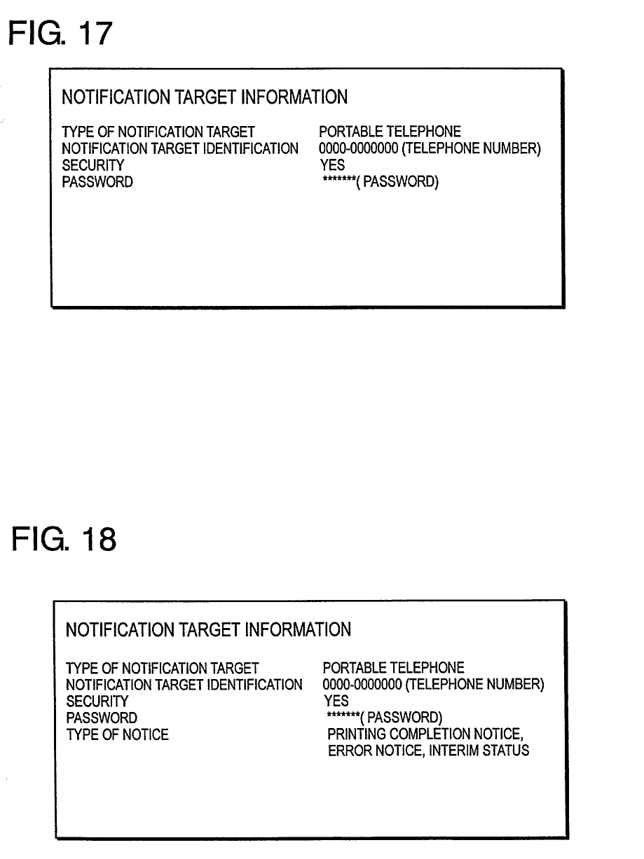

In the step S1145, the notification target information is prepared based on the information set up in the step S1130. The notification target information includes at least the information concerning the portable terminal 700 (“notification target's portable terminal information”). An example of the target notification is shown in FIG. 17. The notification target information may contain information concerning the type of status information (“notification type information”) as shown in FIG. 18. In this case, the user A can chose an arbitrary type of notification from various pre-registered statuses. Moreover, the password information contained in the notification target information can be enciphered in order to increase the security.

In the step S1150, the status notification designation screen is erased and the process returns to the step S1105. Thus, the input device 110 and the display 112 of the PC 100 function as the designating means for designating the portable terminal 700 that receives the status information.

After that, the process returns to the main flowchart of FIG. 13. In the step S1200, the notification target information prepared in the step S1100 is added to the printing job assigned to the digital copying machine 200.

In the step S1300, the printing job is transmitted to the digital copying machine 200 via the network interface 114 and the network 600, thus completing a series of processes shown in FIG. 13. As a result, the notification target information containing the information concerning the designated portable terminal 700 is attached to the printing job to be transmitted to the digital copying machine 200.

As can be seen from the above, the PC 100 that transmits the printing job can also designate a portable terminal 700 that receives the status information. It can also transmit the information concerning the designated portable terminal 700 to the digital copying machine 200, which is the job-executing device, via the network 600.

<Process of the Digital Copying Machine as the Job-executing device>

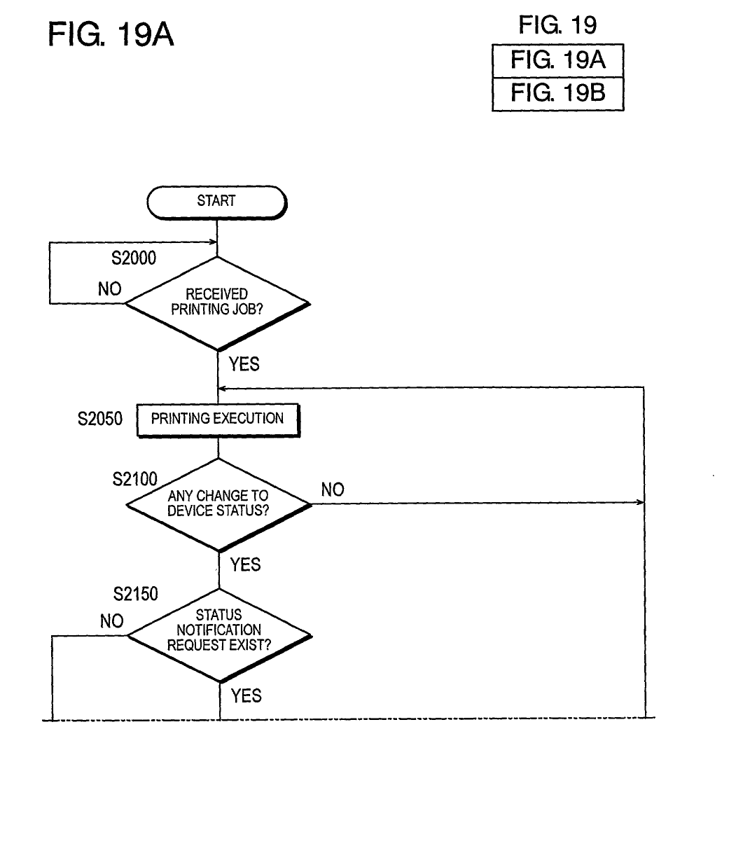

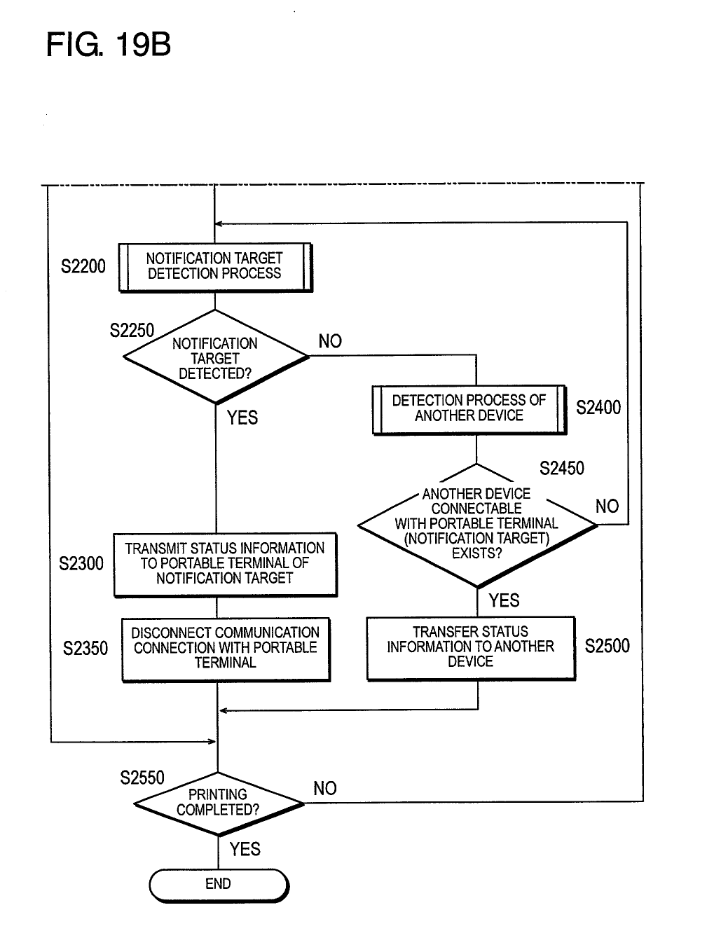

FIG. 19A and FIG. 19B are flow charts showing the status notification operation of a digital copying machine 200 corresponding to the first embodiment of the present invention. The process shown in the flowcharts of FIG. 19A and FIG. 19B is stored in the ROM 204 of the digital copying machine 200 as a control program and the CPU 202 executes the control program.

In the step S2000, a judgment is made as to whether the operation request is received via the network interface 214. More specifically, a judgment is made as to whether the printing job is received. If the printing job is received (S2000: Yes), the process advances to the step S2050. If the printing job is not received (S2000: No), the process advances to the next step after the printing job is received.

In the step S2050, a process is executed for causing the print unit 222 to execute the printing job.

In the step S2100, a judgment is made as to whether any changes occurred in the status of the digital copying machine 200 based on the signal from the print unit 222 as well as signals from various sensors not shown. In other words, a judgment is made as to whether any circumstances to be notified as the status information occurred. If the status of the digital copying machine 200 has changed (S2100: Yes), the process advances to the step S2150. If the status change has not changed (S2100: No), the process returns to the step S2050, and the printing job execution continues.

In the step S2150, a judgment is made as to whether any status notification request exists. This judgment is made based on whether the notification target information is received. More specifically, this judgment is made based on whether the notification target information is attached to the print job received in the step S2000. If a status notification request exists (S2150: yes), the process advances to the step S2200. If no status notification request exists (S2150: No), the process immediately advances to the step S2550.

If a status notification request exists, a device that is capable of short-distance communications with the designated portable terminal 700 will be detected among various devices including the PC 100, the digital copying machine 200, the printer 300, the facsimile 400 and the scanner 500 shown in FIG. 1 as described in detail later. In other words, a device which has local interface for short-distance communications with the portable terminal 700(i.e., the notification target), and which is currently in a condition of conducting short-distance communication with the portable terminal 700.

The detection process by the digital copying machine 200 is executed on the basis of the processes shown in the step S2200 and the step S2400. In other words, the detection process is executed in two stages. First, as the first stage, a judgment is made as to whether the digital copying machine 200 itself that executes the job is in the condition of conduction short-distance communications with the designated portable terminal 700. Next, as the second stage, if the digital copying machine 200 itself is not in the condition of conduction short-distance communications with the designated portable terminal 700, a device that is to conduct short-distance communications with the portable terminal 700 is chosen from various devices different from the digital copying machine 200.

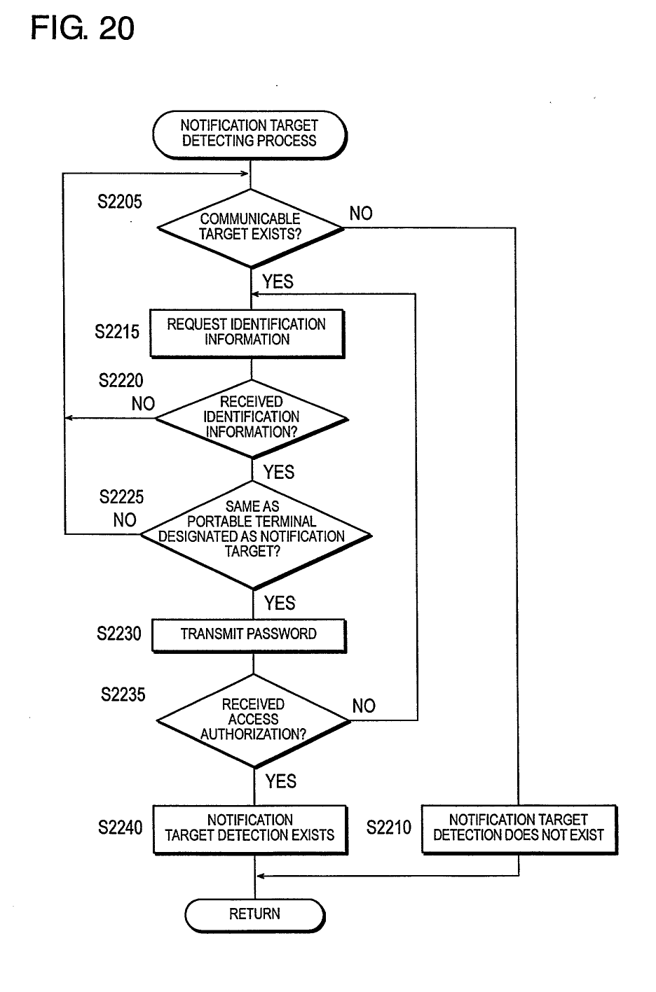

FIG. 20 is a flowchart showing the content of the notification target detection process of the step S2200 shown in FIG. 19B. More specifically, FIG. 20 corresponds to the first stage of the abovementioned detection process.

In the step S2205, the digital copying machine 200 makes a judgment whether there exists a portable terminal 700 that is connectable with the local interface 224 of the digital copying machine 200. This judgment is made based on whether a signal is received in response to a signal transmitted from the local interface 224. If a portable terminal 700 that is connectable with the local interface 224 exists (S2205: Yes), the process advances to the step S2215. If no portable terminal 700 that is connectable with the local interface 224 exists (S2205: No), the process advances immediately to the step S2210.

In the step S2210, the process returns to the main flowchart of FIG. 19B in case no portable terminal 700 to be notified can be detected.

On the other hand, in the step S2215, an identification information request is made to the portable terminal 700, which is the source of the response signal, via the local interface 224. The identification information is specific information, for example, a telephone number, intrinsic to each portable terminal 700.

In the step S2220, a judgment is made as to whether identification information is received from the portable terminal 700, to which the identification information is requested, via the local interface 224. If the identification information is received (S2220: Yes), the process advances to the step S2225. If no identification information is received (S2220: No), the process returns to the step S2205.

In the step S2225, a judgment is made as to whether the identification information received in the step S2220 is identical with the identification information included in the notification target information by comparing them. If the received identification information is identical with the identification information of the notification target (S2225: Yes), the process advances to the step S2230. If the received identification information is not identical with the identification information of the notification target (S2225: No), the process returns to the step S2205.

In the step S2230, the password contained in the notification target information is transmitted via the local interface 224 to the portable terminal 700 of the identification information request target.

In the step S2235, a judgment is made as to whether an access authorization is received via the local interface 224 from the portable terminal 700, which received the password in the step S2230. If the access authorization is received (S2235: Yes), the process advances to the step S2240. If the access authorization is not received (S2235: No), the process returns to the step S2215.

In the step S2240, a judgment is made that the designated portable terminal is detected as the notification target of the status information as a result of the above procedure. Consequently, the process returns to the main flowchart of FIG. 19B. Although it has been described so far in this embodiment using a system where the security check is executed, it is possible to eliminate the processes for security checks performed in the step S2230 and the step S2235.

Getting back to the main flowchart of FIG. 19B, a judgment is made in the step S2250 whether the notification target is detected based on the result of the notification target detecting process of the step S2200. If the notification target is detected (S2250: Yes), it means that the digital copying machine 200 itself is capable of short-distance communications with the designated portable terminal 700. Therefore, the process advances to the step S2300. On the other hand, the notification target is not detected (S2250: No), it means that the digital copying machine 200 itself is not capable of short-distance communications with the designated portable terminal 700. Therefore, the process advances to the step S2400 in order to detect another device different from the digital copying machine 200, which is capable of short-distance communications with the designated portable terminal 700.

In the step S2300, the status information of the digital copying machine 200 is transmitted to the portable terminal 700, which is the notification target, via the local interface 224 as a status change occurs in the digital copying machine.

In the step S2350 of FIG. 19B, a process is executed for disconnecting the communication connection with the portable terminal 700, which is the notification target. For example, the process of disconnecting the communication connection contains the transmission of the communication completion and the reception of the connection-disconnecting signal. After that, the process advances to the step S2550.

On the other hand, in the step S2400, another device that is capable of short-distance communications with a designated portable terminal 700 is detected (another device detection process). Another device here means a device different from the device that is actually executing the job (the digital copying machine 200).

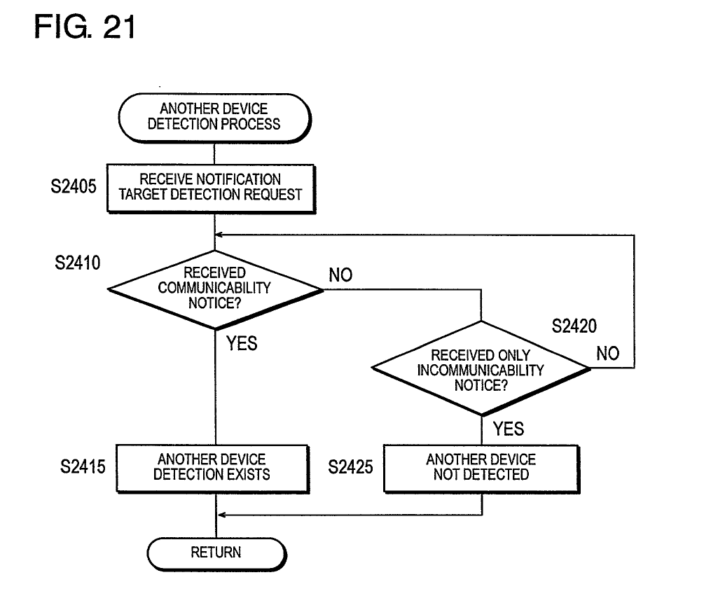

FIG. 21 is a flowchart that shows the content of another device detection process in the step S2400 of FIG. 19B. More specifically, FIG. 21 corresponds to the aforementioned second stage of the detection process.

In the step S2405, a notification target detection request is transmitted to all the devices connected to the network 600 via the network interface 214. The notification target detection request is an order sent to all the devices connected to the network 600 to check if they are capable of short-distance communications with the portable terminal, which is the notification target. In this embodiment, the notification target detection request is transmitted to an unspecified number of devices within the network. For example, broadcast packet communication is used for transmission process of the notification detection request. The notification target detection request contains the notification target information shown in FIG. 17.

In the step S2410, a judgment is made as to whether a notice is received via the network interface 214 from an arbitrary device notifying that it is capable of short-distance communications (“communicability notice”) with the portable terminal 700, which is designated as the notification target. If the communicability notice has been received (S2410: Yes), the process advances to the step S2415. If the communicability notice has not yet been received (S2410: No), the process advances to the step S2420.

In the step S2415, the transmitting source of the communicability notice is recognized as a device communicable with the designated portable terminal 700. Consequently, it is judged that another device is detected and the process returns to the main flowchart of FIG. 19B.

On the other hand, in the step S2420, a judgment is made as to whether a notice is received via the network interface 214 from all the devices notifying that they are all incapable of conducting communications with the designated portable terminal 700(“incommunicability notice”). If the incommunicability notice has been received from all the devices (S2420: Yes), the process advances to the step S2425. If the communicability has not been received from all the devices yet (S2420: No), the process returns to the step S2410.

When the incommunicability notice is received from all the devices, it is judged that another device that is capable of short-distance communications with the designated portable terminal 700 does not exist, as the process in the step S2425. Thus, it is judged that “no other device is detected” and the process returns to the main flowchart of FIG. 19B.

In the step S2450 of the main flow chart of FIG. 19B, a judgment is made as to whether another device capable of short-distance communications with the designated portable terminal is detected based on the abovementioned another device detection process. If another device is detected (S2450: Yes), this other device is detected as the device that is communicable with the designated portable terminal 700. Consequently, the process advances to the step S2500. On the other hand, if another device is not detected (S2450: No), it is determined that there is no device that is capable of short-distance communications with the designated portable terminal 700, and the process returns to the step S2200.

In the step S2500, the status information of the digital copying machine 200 that executes the job is transferred to the device detected in the step S2400 and the step S2450 via the network interface 214. Consequently, the process advances to the step S2550.

In the step S2550, a judgment is made as to whether the printing job received in the step S2000 is completed. If the printing has not been completed (S2550: No), the process returns to the step S2050. If the printing has been completed (S2550: Yes), a series of operations shown in FIG. 19A and FIG. 19B are finished.

As can be seen from the above, the digital copying machine 200, which is the job-executing device, detects from various devices connected to the network a device that is communicable with the portable terminal designated as the notification target of the status information. If the detected device is not the digital copying machine itself, which is currently executing the job, the job information is transmitted to the detected device via the network 600.

<Process on a Device that is Different from the Digital Copying Machine 200, which is the Device Executing the Job>

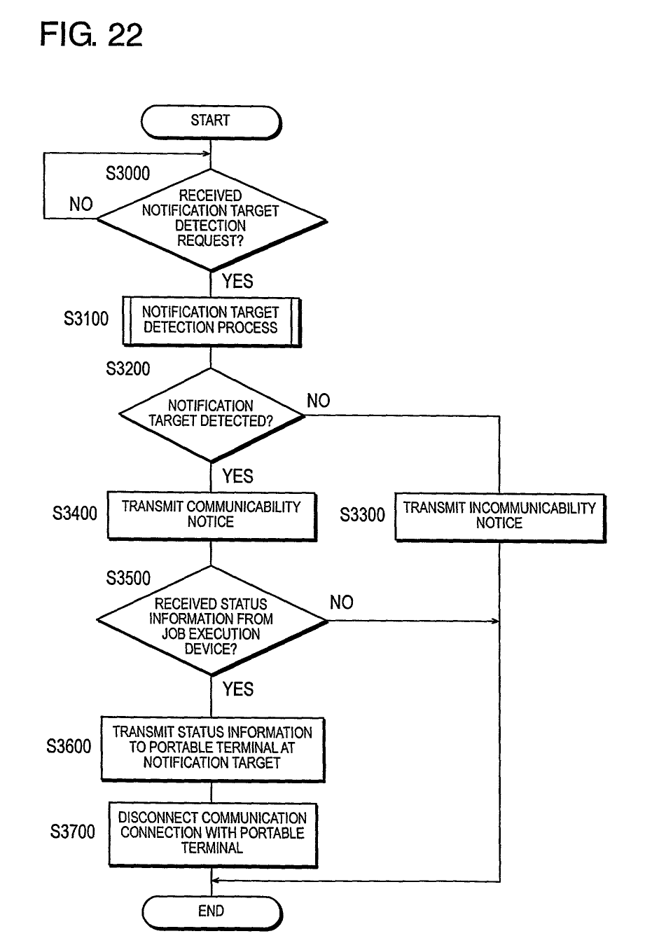

Now, let us describe the operation on a device that is different from the job executing device. In other words, let us describe the operation of the device that transmits the status information to the portable terminal 700. FIG. 22 is a flowchart that shows the operation of another device, which is different from the device that is currently executing the job. The process shown in the flowchart of FIG. 22 is stored in the ROM of each device and the CPU executes the control program. Let us describe the situation using the printer 300 as an example. The control program in stored in the ROM 304 and is executed by the CPU 302. The printer 300 is assumed here to be a type of printer that is equipped with the local interface 324 shown in FIG. 5.

In the step S3000, a judgment is made as to whether the notification target detection request described in the step S2405 is received via the network interface 314. If the notification target detection request is received (S3000: Yes), the process advances to the step S3100. If the notification target detection request is not received (S3000: No), the process waits until the notification target detection request is received.

In the step S3100, a judgment is made as to whether the portable terminal 700, which is designated as the notification target, exists within its own communication area. The communication target detection process is identical to the flowchart shown in FIG. 20.

In the step S3200, a judgment is made as to whether the notification target is detected based on the result of the notification detection process of the step S3100. If the notification target has not been detected (S3200: No), it is judged that the printer 300 is not capable of short-distance communications with the portable terminal 700 designated as the notification target and the process proceeds to the step S3300. If the portable terminal 700, which is designated as the notification target, is detected (S3200: Yes), the printer is judged to be capable of short-distance communications with the portable terminal 700 designated as the notification target and the process proceeds to the step S3400.

In the step S3300, as this device is not capable of short-distance communication with the designated portable terminal 700, the incommunicability notice is transmitted to the digital copying machine 200, which is the notice target detection request source, via the network interface 314, thus completing a series of processes shown in FIG. 22.

In the step S3400, as the printer 300 is capable of short-distance communications with the designated portable terminal 700, the communicability notice is transmitted to the digital copying machine 200, which is the notice target detection request source, via the network interface 314.

In the step S3500, a judgment is made as to whether status information is received from the digital copying machine 200 via the network interface 314 within the specified setup time. If the status information is received within the specified time (S3500: Yes), the process advances to the step S3600; if the status information is not received within the specified time (S3500: No), a series of operations shown in FIG. 22 are finished. If the status information is not received within the specified time, it may be a case where there are multiple devices that are capable of conducting multiple communications with the designated portable terminal 700, and a device different from this printer 300 is chosen as the device to transmit the status information to the portable terminal 700. It can be constituted preferably in such a way that a device, which transmits the communicability notice ahead of others, gets to be chosen as the device to conduct short-distance communications with the designated portable terminal 700, if there are more than one device that can conduct short-distance communications with the designated portable terminal 700.

In the step S3600, as shown in the case 2 of FIG. 1, the status information of the digital copying machine 200 received in the step S3500 is transmitted via the local interface 324 to a portable terminal 700, for example, the portable telephone 700a, which is designated as the notification target.

In the step S3700, the communication connection with the portable terminal 700 is disconnected as a process at the completion of the status information transmission, thus completing a series of processes shown in FIG. 22.

Therefore, if a device other than the digital copying machine 200 executing the printing job, is detected as a device that is capable of short-distance communications with the designated portable terminal 700, the detected device can receive the status information from the digital copying machine 200 via the network 600, and transmit the status information to the portable terminal via the local interface intended for short-distance communications.

<Process on the Portable Terminal>

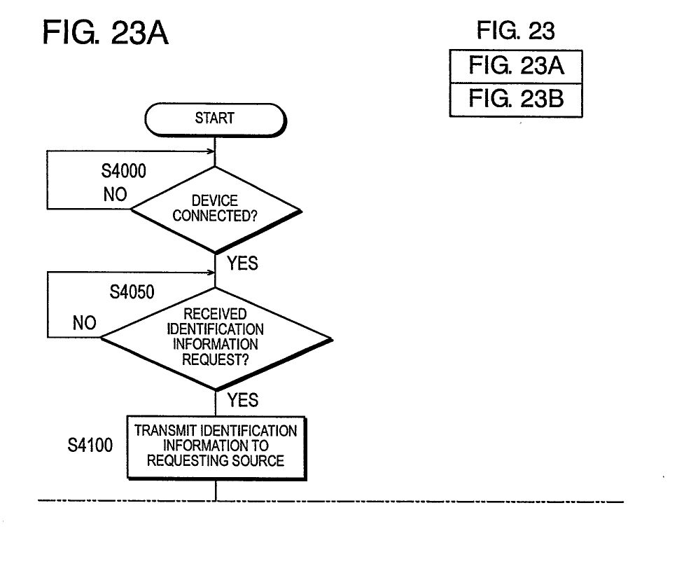

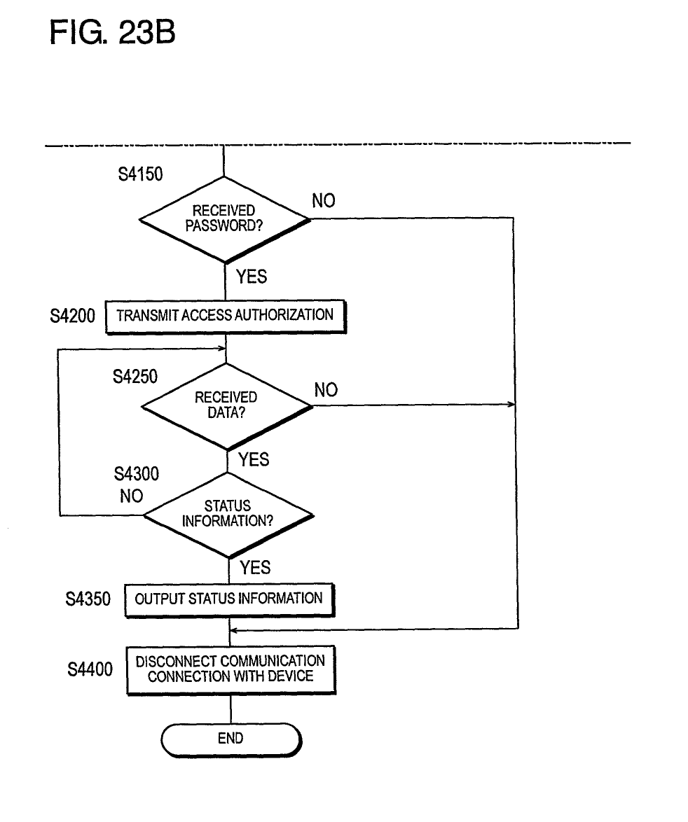

FIG. 23A and FIG. 23B are flowcharts showing operations of the portable telephone 700a designated as the notifying target. The process shown in the flowchart of FIG. 23A and FIG. 23B is stored in the ROM 704 of the portable telephone 700a as a control program, and the CPU 702 executes this control program.

In the step S4000, a judgment is made as to whether at least an arbitrary device is connected to the local interface 724. The connection between the portable telephone 700a (portable terminal 700 in general) and the device connected with the network 600 is established by means of exchanging specified signals via each of their local interfaces. If the connection is established (S4000: Yes), the process advances to the step S4050. If the connection is not established (S4000: No), the portable terminal waits until the connection is established.

In the step S4050, a judgment is made as to whether an identification information request is received from a device connected to the local interface 724 (hereinafter called “the connection target device”). If the identification request has been received (S4050: Yes), the process advances to the step S4100. If the identification request has not been received (S4050: No), it waits until the identification request is received from the connection target device. The connection target device is the device detected by the detection process as mentioned above. Therefore, the connection target device can be either a device that is currently executing the job as in the case 1 of FIG. 1 (the digital copying machine 200 in case of the above description), or another device as in the case 2 of FIG. 1 (the printer 300 in the above description).

In the step S4100, identification information, such as a telephone number, is transmitted to the device of the connection target via the local interface 724.

In the step S4150, a judgment is made as to whether a password is received from the connection target device via the local interface 724. More specifically, a comparison is made between the character string stored in the portable terminal as a password and the character string received. If the two character strings match, it is judged that the password is received. If the password is received (S4150: Yes), the process advances to the step S4200. If the password is not received (S4150: No), the process immediately advances to the step S4400. It is possible to constitute, as opposed to this embodiment, in such a way that the process returns to the step S4150, and maintains the condition to wait for the reception of the password, if a character string other than the password is received.

In the step S4200, the access authorization is transmitted to the connection target device via the local interface 724.

In the step S4250, a judgment is made as to whether the data is received from the connection target device via the local interface 724. If the data is received (S4250: Yes), the process advances to the step S4300. If the data is not received (S4250: No), the process immediately advances to the step S4400.

In the step S4300, a judgment is made as to whether the data received in the step S4250 is status information. If the received data is status information (S4300: Yes), the process advances to the step S4350. If the received data is no status information (S4300: No), the process returns to the step S4250.

In the step S4350, the received status information, in other words, the information concerning the process status of the digital copying machine 200, which is the device currently executing the job, is temporarily stored in the RAM 706 and the status information is outputted to the outside. More specifically, the status information is displayed on the screen of the display unit 732, or outputted as the voice from the speaker 734. Consequently, the user will be informed of the status information.

In the step S4400, a process is executed for disconnecting the communication connection with the target device, thus completing the series of processes shown in FIG. 23A and FIG. 23B.

In a case, different from the present embodiment, when the connection target device is a device that does not require security checks, the processes of the step S4150 and the step S4200 are not required.

As can be seen from the above, the portable terminal 700 receives and stores the status information of the digital copying machine 200 from the printer 300, which is a device detected by the detection process.

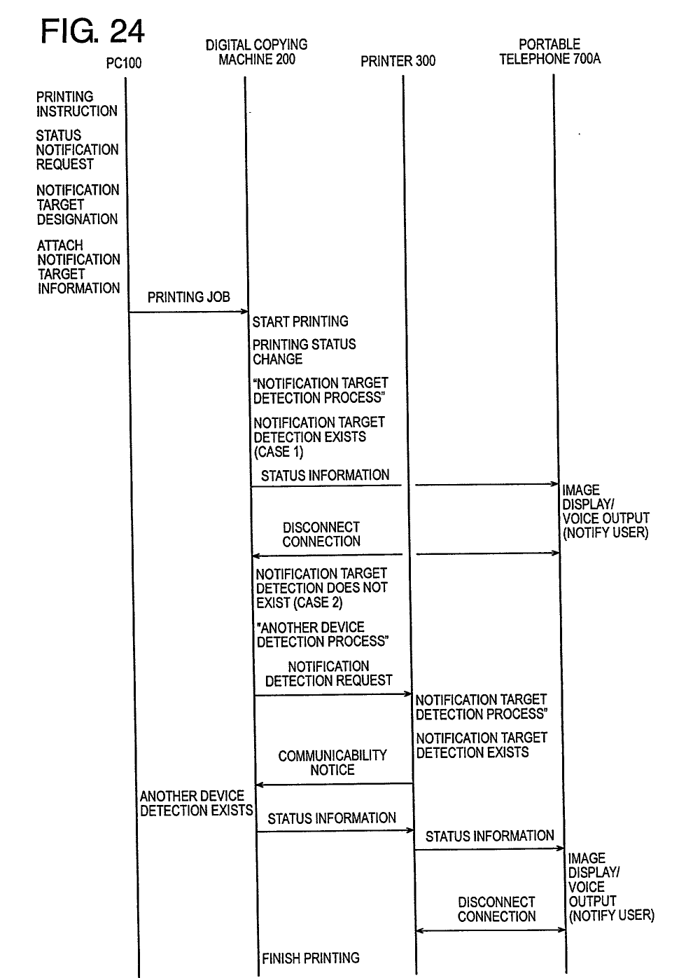

Let us now describe, with reference to each of the abovementioned flowcharts and FIG. 1, the procedural steps of a case, where a printing job is transmitted by the PC 100 to the digital copying machine 200, and the status information concerning the printing operation of the digital copying machine 200 that executes the printing job is transmitted to the user A's portable telephone 700a. The sequence of this operation is as shown in FIG. 24.

The user A enters the status notification request to the PC 100 as an input in addition to the printing instruction. The PC 100 designates the portable telephone 700a as the unit to receive the status information based according to the user A's input operation. The PC 100 also attaches the notification target information to the print job and transmits it to the digital copying machine 200 via the network 600.

The digital copying machine 200 initiates the execution of the printing job as it receives the printing job. During the printing job, the digital copying machine 200 detects a device that is capable of short-distance communications with the portable telephone 700a among various devices, if any changes occur in the status of the digital copying machine 200. The detection of the device can be divided into two categories, i.e., the first case and the second case shown in FIG. 1, which will be discussed in the following.

<Case 1>

Assuming in this case that the user A is moving into the vicinity of the digital copying machine 200 carrying the portable telephone 700a, the notification target detection process is executed as shown in FIG. 20. Since the portable telephone 770a exists in the communication area of the digital copying machine 200 itself, and the digital copying machine 200 itself is capable of short-distance communications with the portable telephone 700a, the digital copying machine 200 transmits its own status information directly to the portable telephone 700a via the local interface 224.

When it receives the status information, the portable telephone 700a displays the contents of the status information on the screen of the display 732 and emits voice output from the speaker 734. Next, the communication termination signal and the disconnection signal are exchanged between the digital copying machine 200 and the portable telephone 700a to disconnect the communication connection.

<Case 2>

Assuming in this case that the user A is moving into the vicinity of the printer 300 carrying the portable-telephone 700a, and either the digital copying machine 200 itself is not in the condition of conducting short-distance communications with the portable telephone 700a, or the digital copying machine 200 itself is not equipped with the local interface for conducting short-distance communications, the aforementioned another device detection process is executed as shown in FIG. 21. The digital copying machine 200 transmits the notification target detection request to each device, and receives the communicability notice from the printer 300. As a result, the printer 300 is detected as the device that is capable of short-distance communications with the portable telephone 700a.

The digital copying machine 200 transmits its own status information to the printer 300 via the network 600.

When it receives the status information of the digital copying machine 200, the printer 300 transmits the received status information to the portable telephone 700a via the local interface 324. Upon receiving the status information, the portable telephone 700a executes a process similar to the one in Case 1.

The above process is repeated until the printing operation of the digital copying machine is completed, each time when an incident occurs that needs notification of the status information.

Although the above descriptions cover the cases where the notification target information is transmitted being attached to the printing job, the invention is not limited to such cases. For example, it is possible to transmit the printing job and the notification target information separately by linking the notification target information with the printing job.

Therefore, according to this embodiment, it is always possible to notify the user of the device status information regardless of where the user moves to or where the user is located, so long as the user's portable terminal 700 is within an area that allows short-distance communications from at least one arbitrary device. Moreover, since it is not dependent on any conventional mobile communication network, it does not cost any communication fee to the user and can achieve a better response compared to the case of transmitting status information via an external device such as an e-mail server.

Next, let us describe several variations of the first embodiment.

(First Variation)

This variation is to transmit a password only with reference to a device detected as a device that is in the condition of conducting short-distance communications with the portable terminal 700. In other words, the first variation differs from the aforementioned first embodiment in the contents of another device detection process shown in FIG. 19B.

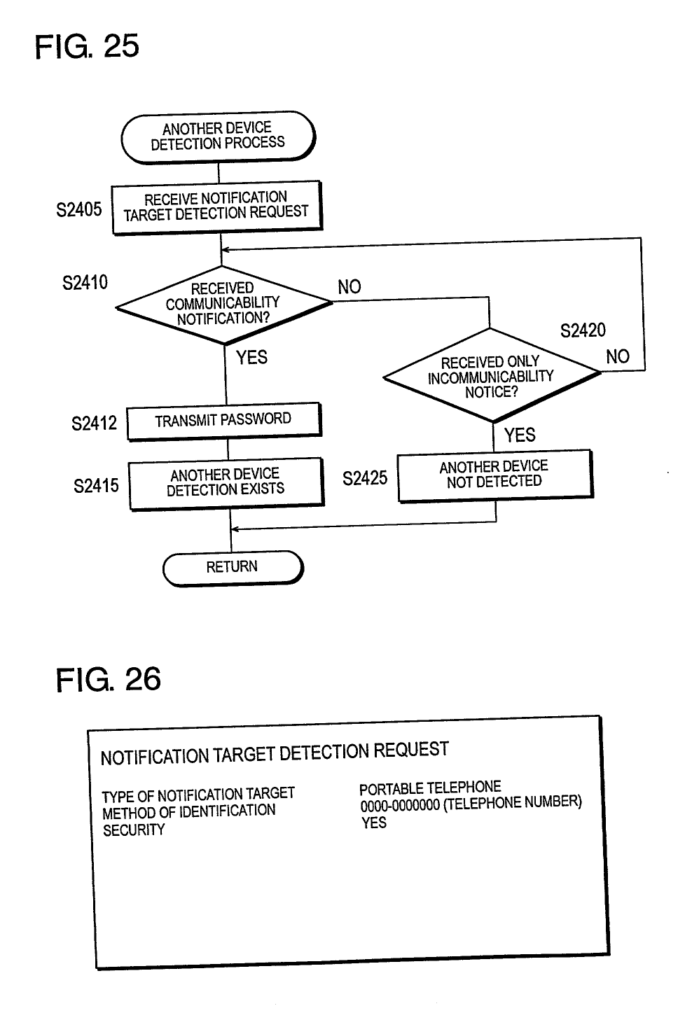

FIG. 25 is a flowchart that shows the content of another device detection process that corresponds to the first variation.

The step S2405 and the step S2410 as well as the step S2415 through S2425 are identical to those in the flowchart shown in FIG. 21. However, the notification detection target request transmitted in the step S2405 in this embodiment does not include a password. An example of the data contained in this notification target detection request is as shown in FIG. 26.

In the step S2412, the password is transmitted via the network 600 only to the transmission source for the communicability notice, i.e., the device that is in the condition of conducting short-distance communications with the designated portable terminal 700. The order of the two processes at the step S2412 and the step S2415 can be reversed at will.

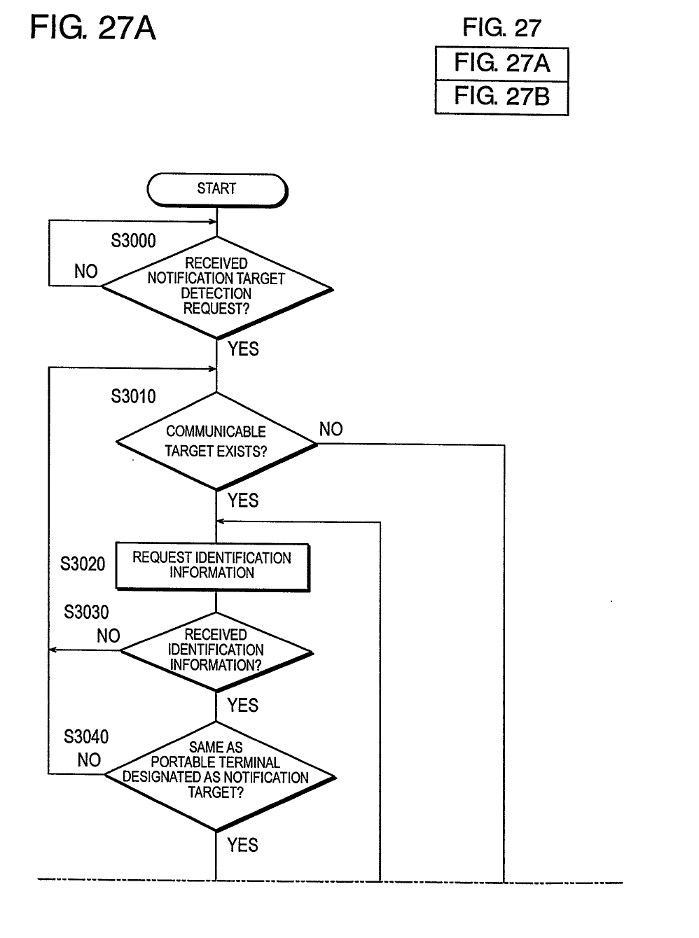

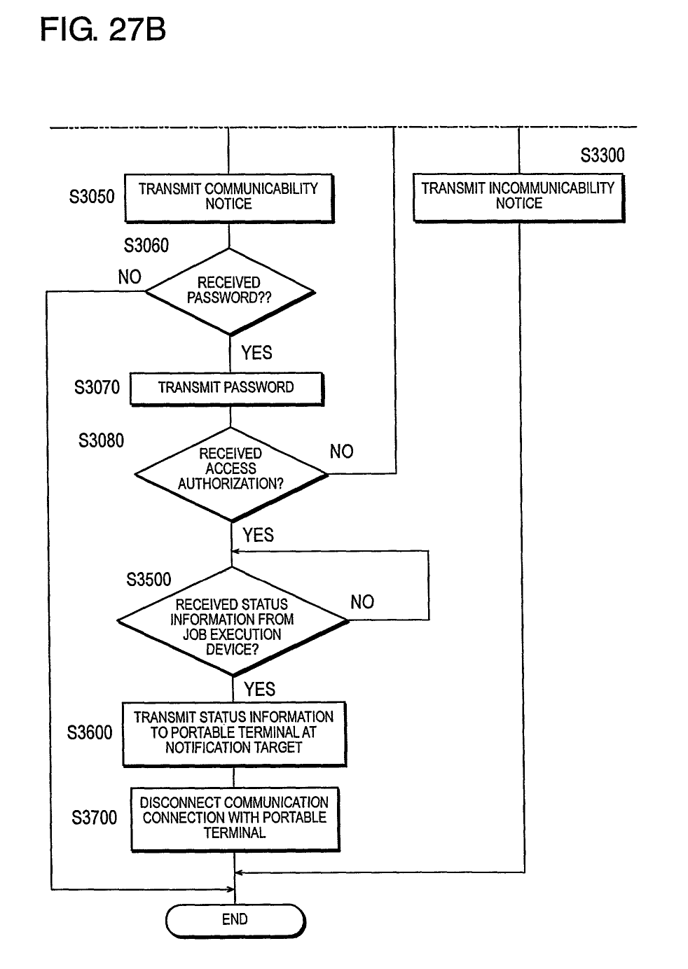

FIG. 27A and FIG. 27B are flowcharts that illustrates another device, i.e., a device different from the digital copying machine 200 that is executing the job in case of the first variation. This will be described below using the printer 300 as an example.

Since the step S3000, the step S3300, S3600, and S3700 are identical to those in the flowchart shown in FIG. 22, their descriptions are not repeated here.

In the step S3010, a judgment is made as to whether there is any portable terminal 700 connectable to the local interface 324. If there is a portable terminal 700 that is connectable to the local interface 224 (S3010: Yes), the process advances to the step S3020. If there is no portable terminal 700 that is connectable to the local interface 224 (S3010: No), the process advances to the step S3300.

Since the steps S3020 through the step S3040 are identical to the steps S2215 through the step S2225 of the flowchart shown in FIG. 20, their descriptions are not repeated here.

In the step S3050, the printer 300 is detected as a device that is capable of short-distance communications with the designated portable terminal 700. As a result, the communicability notice is transmitted to the digital copying machine 200, which is the notice target detection request source, via the network interface 314.

In the step S3060, a judgment is made as to whether the password is received from the digital copying machine 200 via the network interface 314 within the specified time after the communicability notice is received in the step S3050. If the password is received within the specified time (S3060: Yes), the process advances to the step S3070. If the password is not received within the specified time (S3060: No), the series of processes shown in FIG. 27A and FIG. 27B are immediately finished. If no password is received within the specified time, it includes a case where there are multiple devices that are capable of conducting short-distance communication with the designated portable terminal 700 and where another device is chosen as a device for transmitting the status information to the portable terminal 700.

In the step S3070, the password received in the S3060 go is transmitted to the designated portable terminal 700 via the local interface 224.

In the step S3080, a judgment is made as to whether the access authorization is received from the designated portable terminal 700 via the local interface 224. If the access authorization is received (S3080: Yes), the process advances to the step S3500. If the access authorization is not received (S3080: No), the process returns to the step S3020.

In the step S3500, a judgment is made as to whether the status information is received from the digital copying machine 200 via the network interface 314. If the status information is received (S3500: Yes), the process advances to the step S3600. If the status information is not received (S3500: No), the process waits until the status information is received.

(Second Variation)

The feature of this variation is that a portable terminal 700 to receive the status information is preregistered for each device (e.g., PC 100). Therefore, once a portable terminal 700 is registered for receiving the status information, the status information is automatically transmitted to the preregistered portable terminal 700 when the job is registered from the PC 100, unless the registration content is not changed. The operation of registering the portable terminal 700 to be designated as the transmission target can be performed according to the same procedure as shown in the flowchart of FIG. 14.

Thus, this variation saves the user from having to perform the input operation for designating the portable terminal 700 each time.

(Third Variation)

The feature of this variation is that it automatically prepares a notifiable target list that lists portable terminals that are in the condition of conducting short-distance communications. A portable terminal to receive the status information is designated from said list of portable terminals.

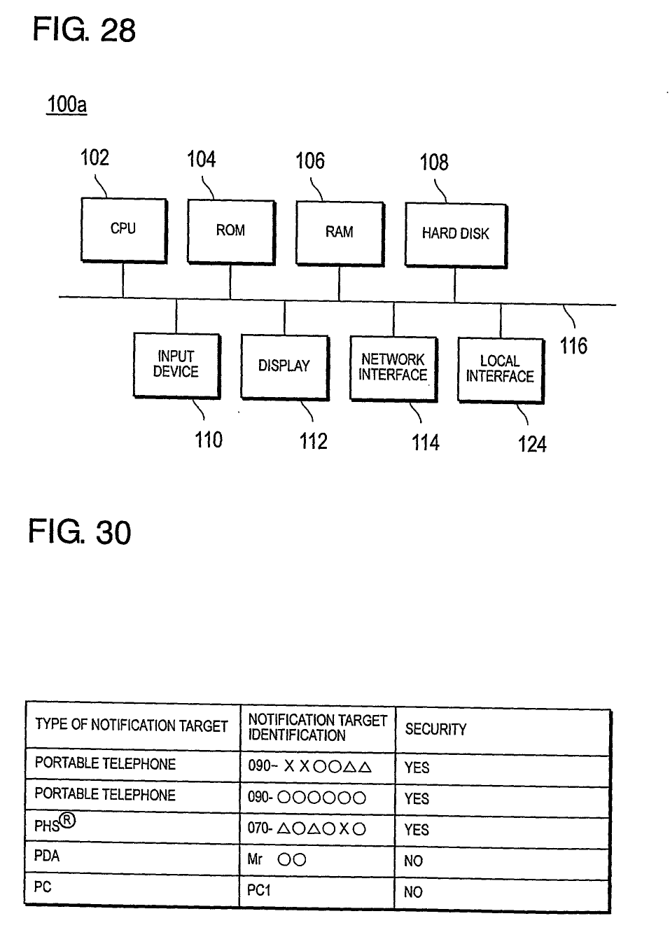

First, let us describe the process of a case where the local interface 124 for conducting short-distance communications with the portable terminal 700 is provided on a device intended to receive the job such as the PC 100a shown in FIG. 28.

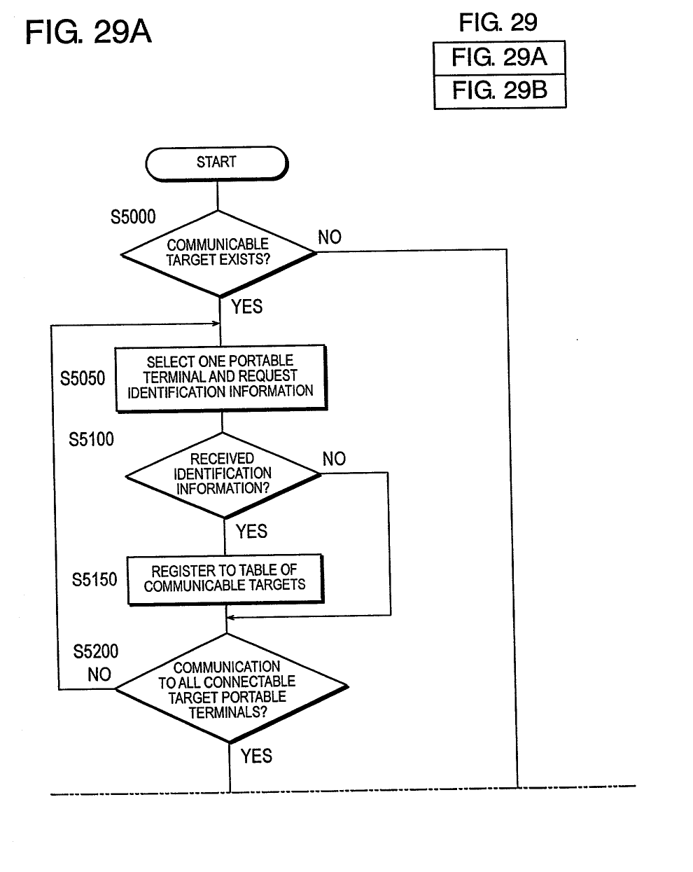

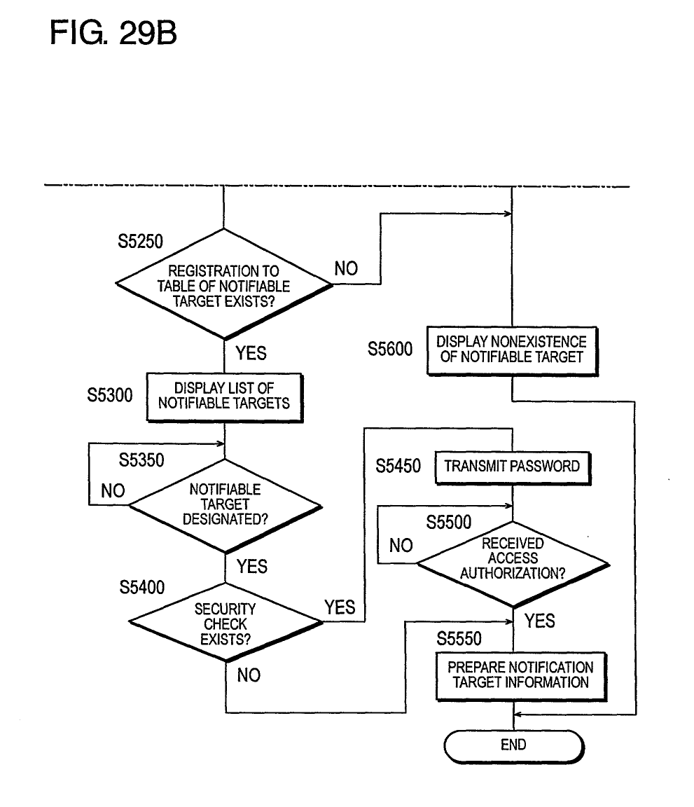

FIG. 29A and FIG. 29B are flowcharts indicating the operation of the PC 100a that corresponds to this variation. The process shown in the flowchart of FIG. 29A and FIG. 29B is stored in the ROM 104 or the hard disk 108 of the PC 100a as a control program and the CPU 102 executes this control program.

In the step S5000, a judgment is made as to whether the portable terminal 700 exists, which is to be connected to the local interface 124 of the PC 100a that transmits the printing job. If the connectable portable terminal 700 exists (S5000: Yes), the process advances to the step S5050. If the connectable portable terminal 700 does not exist (S5000: No), the process advances to the step S5600. As a result, it displays that no locally communicable terminal exits.

In the step S5050, the portable terminals 700 are automatically chosen one by one from a group of portable terminals 700 that are connectable to the local interface 124. For each portable terminal chosen, identification information such as a telephone number is requested.

In the step S5100, a judgment is made as to whether the identification information is received from the portable terminal 700, which is requested to transmit the identification information. If the identification information has been received (S5100: Yes), the process advances to the step S5150. If the identification information has not been received (S5100: No), the process advances to the step S5200.

In the step S5150, the portable terminal 700, which received the identification information at the step S5100, is registered to the notifiable target table stored in the RAM 106 or the hard disk 108. An example of such a notifiable target table is shown in FIG. 30.

In the step S5200, a judgment is made as to whether the request for identification information has been sent to all the portable terminals 700 that are connectable to the local interface 124. If any portable terminal 700 has not yet received the request for identification information (S5200: No), the processes of the steps S5050 through S5150 are repeatedly executed. If the request for identification information has been made to all the portable terminals, the process advances to the step S5250.

In the step S5250, a judgment is made as to whether the portable terminal 700 is registered in the notifiable target table. If the portable terminal 700 is not registered (S5250: No), the process proceeds to the step S5600. As a result of this, the display unit 112 displays nonexistence of communicable portable terminal 700. If the portable terminal 700 is registered (S5250: Yes), the process advances to the step S5300.

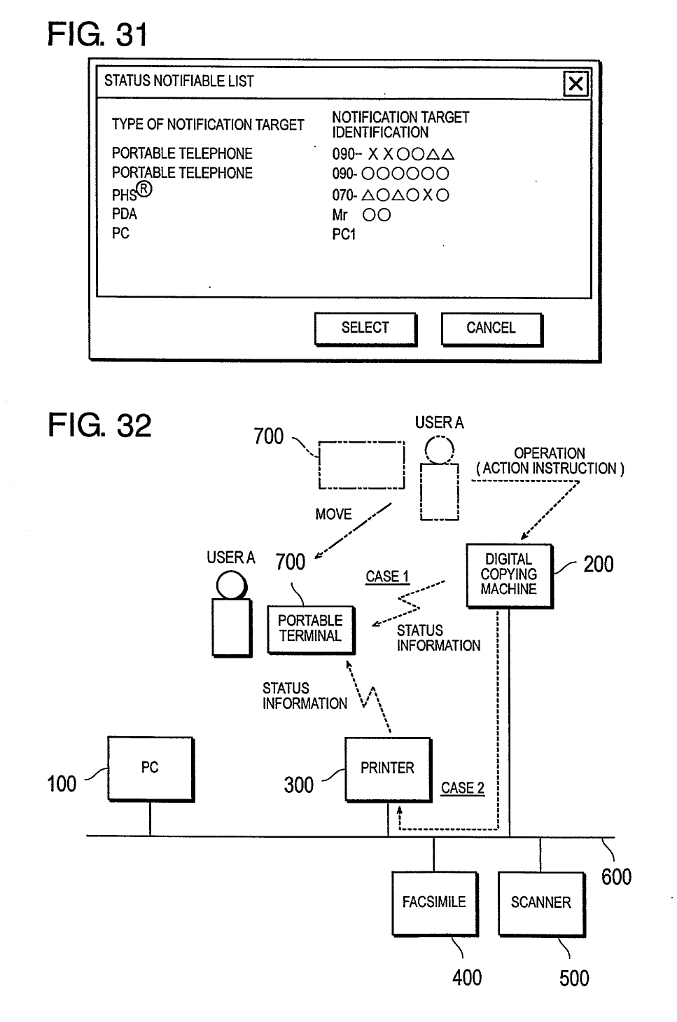

In the step S5300, the communicable target list is displayed on the display unit 112 based on the communicable target table as shown in FIG. 30. FIG. 31 shows an example display screen.

In the step S5350, a judgment is made as to whether the user A designated a notification target, i.e., a portable terminal 700 to which the status information is to be transmitted. This judgment is made based on whether the notification target signal has been received from the input device 110 based on the user's input operation. If the user A has designated the notification target (S5350: Yes), the process advances to the step S5400. If the user A has not designated the notification target (S5350: No), the waiting condition continues until the user A designates the notification target.

In the step S5400, a judgment is made as to whether the security check is done by the portable terminal 700, which is designated as the notification target, in the step S5350. The judgment is made by means of looking up the notifiable target list. If the security check has been done (S5400: Yes), the process advances to the step S5450. If the security check has not been done (S5400: No),the process immediately advances to the step S5550.

In the step S5450, the password is transmitted to the designated portable terminal 700. The password transmitted at this time is entered from the input device 110 by the user A.

In the step S5500, a judgment is made as to whether the access authorization has been received from the portable terminal 700 to which the password was transmitted. If the access authorization is received (S5500: Yes), the process advances to the step S5550. If the access authorization is not received (S5500: No), the waiting condition continues until the user A designates the notification target.

In the step S5550, a notification target information concerning the portable terminal 700, i.e., the notification target of the status information as shown in FIG. 17, is prepared. The notification target information is attached to the print job and is transmitted to the digital copying machine 200.

Therefore, according to this variation, the job transmitting device (the PC 100a in this case) automatically detects portable terminals 700 in the condition of conducting short-distance communications, makes a list of them, and designates an appropriate portable terminal as the notification target from the list. Thus, the input operation concerning the designation of the portable terminal by the user can be grossly simplified.

This variation can be applied also to a case wherein the job transmitting device, for example, the PC 100, is not equipped with the local interface. In this case, the PC 100 obtains via the network 600 the table, in which the portable terminals 700 that are connectable to the local interface of other devices on the network 600. As a consequence, the portable terminals 700 listed up are displayed on the display unit 112 of the PC 100. The user can designate using the input device 110 an appropriate portable terminal 700 from the listed portable terminals 700.

(Fourth variation)

The feature of this variation is that it is capable of notifying the designated portable terminal of the status information by communicating via a conventional mobile communication network, not via the short-distance communication unit, when it is found that there is no device in the condition of conducting short-distance communications with the designated portable terminal after trying to detect a device that is in the condition.

In other words, if the portable terminal is located within a short distance from the device on the network, the status information can be transmitted to the portable terminal by means of short-distance communication, which has a better response quality and costs nothing in terms of communication fees. On the other hand, if the portable terminal is not located within a short distance from the device on the network, the status information can be transmitted to the portable terminal by means of e-mail, etc., via a conventional mobile communication network containing a base station. Thus, it can prevent the status information from being missed to be notified to the portable terminal.

It is possible to constitute the system in such a way as to notify only via short-distance communication or to constitute it to allow an arbitrary selection between notification via short-distance communication or via conventional mobile communication as shown in this variation.

### Second Embodiment

FIG. 32 is a block diagram showing an example constitution of the status notification system concerning the second embodiment of the invention. The constituting elements in this diagram are coded identical to the corresponding items in the system of the first embodiment shown in FIG. 1, and the description of those identical items are not repeated here.

In the description of the first embodiment, it is assumed that the job-transmitting device (e.g., the PC 100) designates the portable terminal 700, which is the notification target of the status information. In the present embodiment, different from the first embodiment, a job-executing device, for example, the digital copying machine 200, designates the portable terminal 700, which is the notification target of the status information. Therefore, in the second embodiment, the present invention can be applied to a case where the digital copying machine 200 can execute a copying job by itself. In other words,the present invention can be applied to a case where there is no device to transmit the job to, i.e., job issuing and execution can be done by a single device.

This embodiment will be described below using a case where the status information concerning the processing status of the copying job by the digital copying machine 200 is transmitted to the user A's portable telephone 700a in a case where the digital copying machine 200 is to execute the copying job as shown here in FIG. 32.

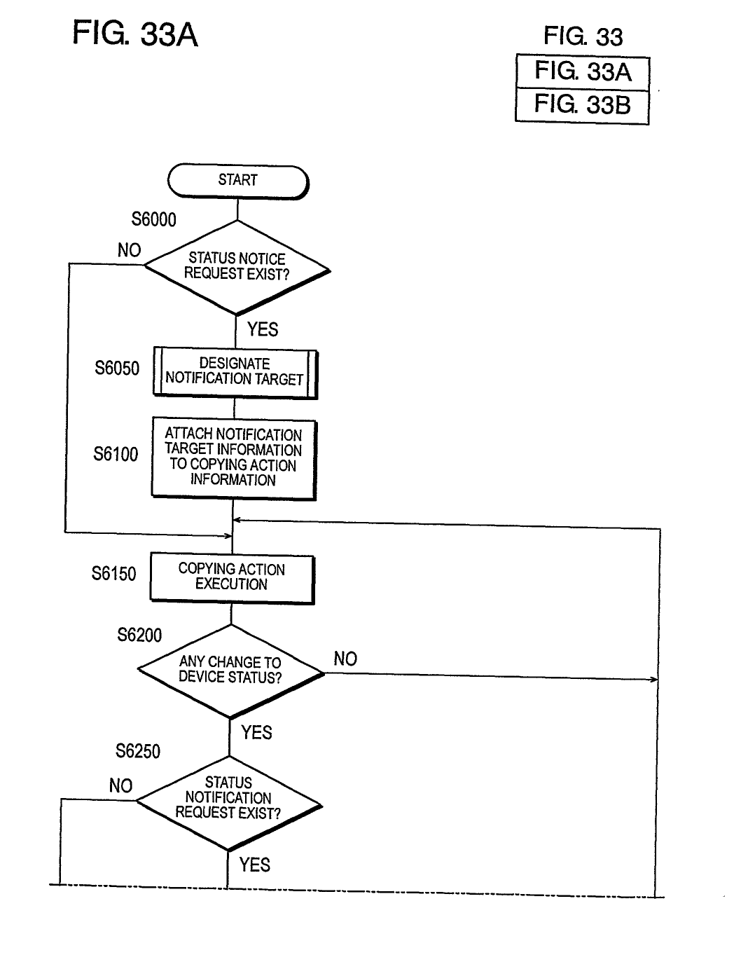

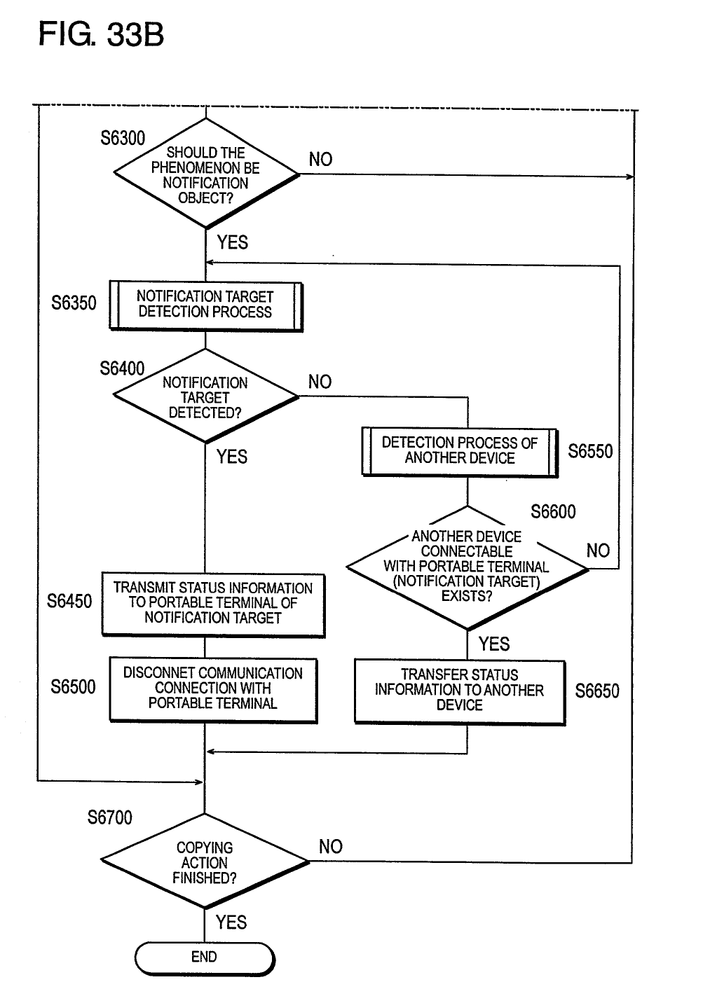

FIG. 33A and FIG. 33B are flowcharts showing the operation of the digital copying machine 200 corresponding to the second embodiment. The process shown in the flowchart of FIG. 33A and FIG. 33B is stored in the ROM 204 of the digital copying machine 200 as a control program and the CPU 202 executes this control program.

In the step S6000, a judgment is made as to whether the user requests the status information. In other words, a judgment is made as to whether a status request exists. This judgment is based on whether a signal corresponding the status notification request has been acquired from the operating panel 218 based on the specified input operation by the user A. If the status notification request has been acquired (S6000: Yes), the process advances to the step S6050. If the status notification request has not been acquired (S6000: No), the process immediately advances to S6150

In the step S6050, the status information notification target is designated. In this case, the user A's portable telephone 700a is designated. The process in the step S6050 is the same as the process described with reference to the flowchart of FIG. 14 for the first embodiment.

In the step 56100, the notification target information prepared in the step S6050 is added to the copying operation information of the digital copying machine 200. Since there is a possibility that multiple copying jobs are executed continuously in series as a result, the notification target information is correlated for each copying job.

In the step S6150, the process for causing the scan unit 220 and the print unit 222 to execute the copying operations based on the copying operation information is executed. As a result, the scan unit 220 and the print unit 222 execute the copying jobs.

In the step S6200, a judgment is made as to whether there are any changes in the status of the digital copying machine 200 based on the signals from the scan unit 220 and the print unit 222 and the signals from various sensors (not shown). If there is any change to the status of the digital copying machine 200 (S6200: Yes), the process advances to the step S6250. If there is no change to the status of the digital copying machine 200 (S6200: Yes), the process returns to the step S6150.

In the step S6250, a judgment is made as to whether a status notice request exists. More specifically, if there is a status notice request is attached to the copying operation information. In other words, a judgment is made as to whether a notice target information is related to the copying job. If a status notice request exists (S6259: Yes), the process advances to the step S6300. If no status notice request exists (S6250: No), the process advances to the step S6700.

In the step S6300, a judgment is made as to whether the status change of the digital copying machine 200 detected in the step S6200 is an object to be notified. This judgment is made by referencing the notification type information contained in the notification target information as shown in FIG. 18. If the detected status change is the object of the notification (S6300: Yes), the process advances to the step S6350. If the detected status change is not the object of the notification (S6300: No), the process returns to the step S6150.

The step S6350 through the step S6650 are identical to the step S2200 through the step S2500 of the flowchart shown in FIG. 19B.

In the step S6700, a judgment is made as to whether the copying operation by the scan unit 220 and the print unit 222 is completed. If the copying operation has not been completed (S6700: No), the process returns to the step S6150 to continue the copying operation. If the copying operation has been completed (S6700: Yes), the series of processes shown in FIG. 33A and FIG. 33B are finished.

The operations of other devices, other than the digital copying machine 200 that executes the job, for example, the operation of the printer 300, and the operation of the portable terminal 700 are identical to the operations shown in the flowcharts shown in FIG. 22, FIG. 23A, and FIG. 23B.

As can be seen from the above, this embodiment is capable of executing status notifications with a better response inexpensively as the device that executes the job can designate a portable terminal to receive the status information, even when there is no job transmitting device as in a case where the digital copying machine executes the copying job.

The first through fourth variations in the first embodiment are applicable to the second embodiment.

### Third Embodiment

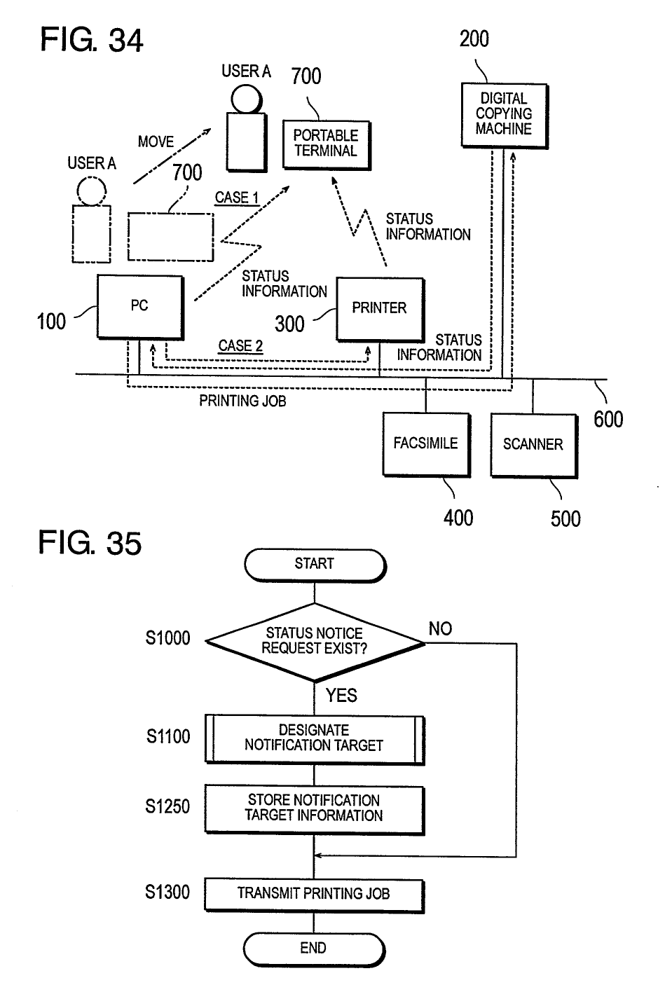

FIG. 34 is a block diagram showing an example of the status notification system constitution according to the third embodiment of the invention. Here again, the constituting elements in this diagram are coded identical to the corresponding items in the network system of the first embodiment shown in FIG. 1, and the description of those identical items are not repeated here.

In the first and second embodiments, the descriptions are based on the cases where the job-executing device is to execute a process of detecting a device that is capable of short-distance communications with the portable terminal, to which the notification is made. In this embodiment, however, it is not the job-executing device but rather it is a communication device, which is communicable with the job-executing device via the network 600, that executes the above mentioned detection process.

The communication device mentioned here is preferably the PC 100a, which is the job-transmitting device. In this case, the digital copying machine 200, which is the job-executing device, transmits the status information to the PC 100a via the network interface 214. The PC 100a detects a device that is capable of short-distance communications with the portable terminal 700 from multiple devices connected to the network 600. If the PC 100a is in the condition of conducting short-distance communications with the designated portable terminal 700, the PC 100a itself conducts short-distance communication with the portable terminal 700 as shown in the case 1 of FIG. 34. If, on the other hand, the PC 100a itself is not in the condition of conducting short-distance communications with the portable terminal 700, another device different from the PC 100a conducts short-distance communication with the portable terminal 700 as shown in the case 2 of FIG. 34. As a consequence, the status information is transmitted to the portable terminal 700. The following description will be for a case where the printing job is transmitted from the PC 100a equipped with the local interface 124 to the digital copying machine 200.

FIG. 35 is a flowchart showing the printing request operation of the PC 100a to be used in the system shown in FIG. 34. The process shown in the flowchart of FIG. 35 is stored in the ROM 104 or the hard disk 108 of the PC 100a as a control program, and the CPU 102 executes this control program.

Since the steps S1000 and S1100 are identical to the steps in the flowcharts shown in FIG. 13 and FIG. 14, their descriptions are not repeated here.

In the step S1250, the notification target information prepared in the step S1100 is stored in the specified area of the RAM 106 linking with the printing job. As a result, even if multiple printing jobs are transmitted in series, the status information can be transmitted for each printing job.

In the step S1300, the printing job is transmitted to the digital copying machine 200.

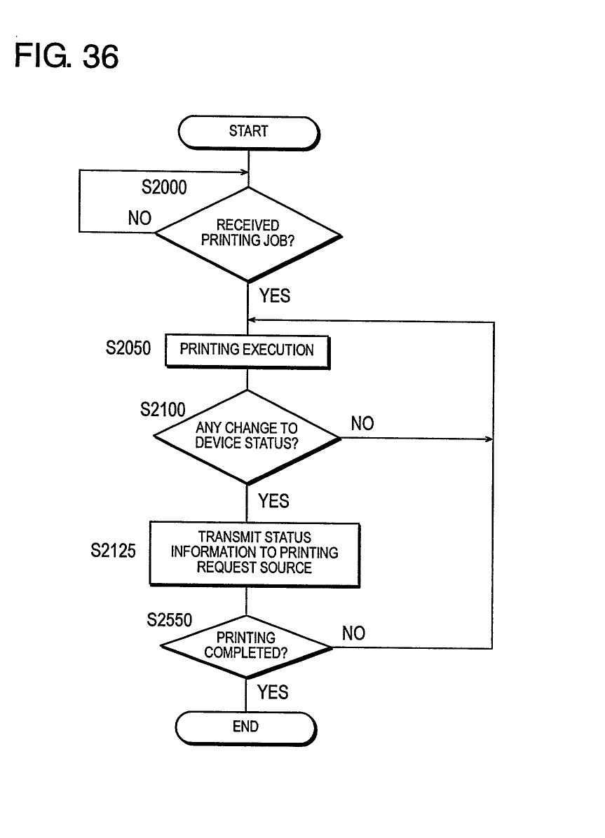

FIG. 36 is a flowchart showing the printing operation of the digital copying machine 200 used in the system shown in FIG. 34. The process shown in the flowchart of FIG. 36 is stored in the ROM 204 of the digital copying machine 200 as a control program and the CPU 202 executes this control program.

Since the steps S2000 through S2100 are identical to the steps in the flowchart shown in FIG. 19A, their descriptions are not repeated here.

In the step S2125, the status information of the digital copying machine 200 detected in the step S2100 is transmitted via the network interface 144 to the device that requests the printing, i.e., the PC 100a, which transmits the job.

Since the step S2550 is identical to the corresponding step in the flowchart shown in FIG. 19B, the description is not repeated here.

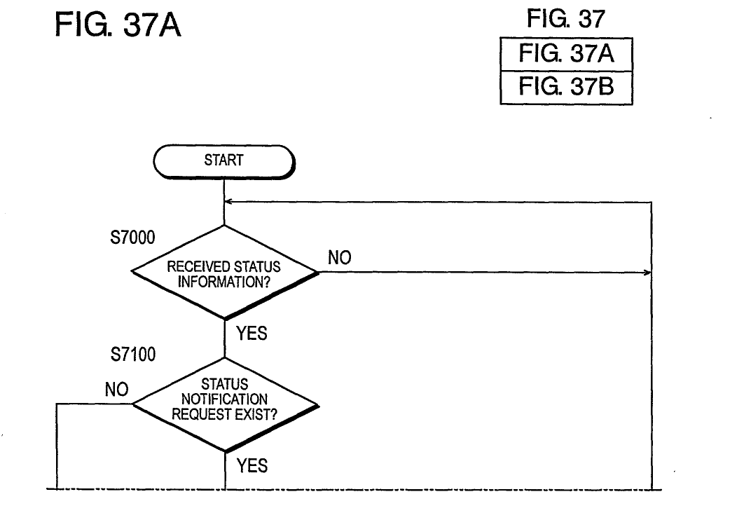

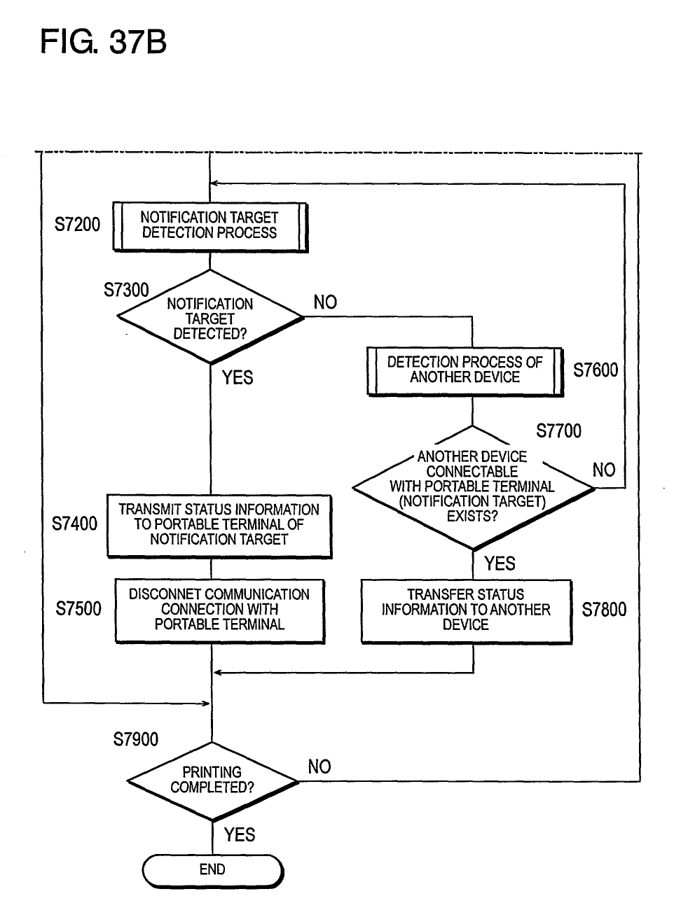

FIG. 37A and FIG. 37B are flowcharts showing the status notification operation of the PC 100a that corresponds to the third embodiment. The process shown in the flowchart of FIG. 37A and FIG. 37B is stored in the ROM 104 of the PC 100a as a control program and this control program is executable by the CPU 102.

In the step S7000, a judgment is made as to whether the status information is received from the digital copying machine 200 via the network interface 114. If the status information is received from the digital copying machine 200 (S7000: Yes), the process advances to the step S7100. If the status information is not received from the digital copying machine 200 (S7000: No), the waiting condition continues until the status information is received from the digital copying machine 200.

In the step S 7100, a judgment is made whether the status notification request is made. This judgment is made based on whether the notification target information corresponding to said printing job is stored in the RAM 106. If the status notification request exists (S7100: Yes), the process advances to the step S7200. If the status notification request does not exist (S7100: No), the process immediately advances to the step S7900.

Since the steps S7200 through S7800 are identical to the steps S2200 through S2500 in the flowchart shown in FIG. 19B, their descriptions are not repeated here. However, the detection process is done not by the job-executing device, i.e., the digital copying machine 2001 but by another device, PC 100a. That is a difference between the first embodiment.

In the step S7900, a judgment is made whether the printing is completed at the digital copying machine 200. This judgment is done based on whether the printing completion signal from the digital copying machine 200. If the printing is not completed (S7900: No), the process returns to the step S7000. If the printing is completed (S7900: Yes), the series of processes shown in FIG. 37A and FIG. 37B is finished.

The operation of the printer 300 and the operation of the portable terminal 700 that correspond to the third embodiment are similar to those operations described based on the flowcharts of FIG. 22, FIG. 23A, and FIG. 23B.

Although this embodiment was described in the above assuming the detection process is executed by the PC 100a, which is the job-transmitting device, the detection process can also be executed by an arbitrary device that is communicable with the job-executing device via the network 600.

According to this embodiment, the job-executing device does not have to have a detection function for detecting a device that is capable of short-distance communications with the designated portable terminal and the detection process can be executed by another device such as a job-transmission device, for example, a PC. Therefore, the present invention can also be applied to a case where a conventional printer or digital copying machine that does not have the detection function is used as a job-executing device, thus to accomplish the execution of status notification with better response inexpensively.

The first through fourth variations of the first embodiment are also applicable to the third embodiment.

The present invention is not limited to the first through third embodiment, but can be modified in various ways by a person skilled in the art. For example, it is possible to use multi-function peripheral device as the job-executing and/or job-transmitting devices deviating from the first through third embodiments. The multi-function peripheral device here is device with multiple functions chosen from the printing function, copying function, scanning function, and facsimile function.

Furthermore, although the first through third embodiments are described in the above that the detecting device detects a device communicable with the portable terminal from all the devices that include the detecting device itself as well, it is also possible to constitute a system in such a way that a device that is capable of short-distance communications with the portable terminal is detected from multiple devices connected to a network of a predetermined scope. For example, the device that executes the detection process can detect a device communicable with the portable terminal from devices other than itself.

Each means of controlling the status notification system as well as the status notification method according to the present invention can be realized by either a programmed computer or a dedicated hardware circuit.

Moreover, in case the present invention is realized by using a programmed computer, the program for operating the computer can be provided by having it stored in a computer readable recording medium (e.g., flexible disk or CD-ROM), or can be provided through a network without recourse to any recording media. This program is typically transferred to a hard disk for storage. The program can also be provided as an application software or a built-in part of the computer's software as part of its function.

What is claimed is:

1. A status information notifying system comprising:
a portable terminal; and a job execution device for executing a job, wherein
said job execution device is equipped with a detector for detecting a device that is capable of short-distance communication with said portable terminal; and
said portable terminal receives status information concerning said job execution device's job processing status via the device detected by said detector.

2. A status information notifying system comprising:
a portable terminal; and multiple devices including a job execution device for executing a job, at least one of which multiple devices is equipped with a short-distance communication unit for conducting short-distance communication with said portable terminal, wherein
said job execution device is equipped with a detector for detecting a device that is capable of short-distance communication with the portable terminal from said multiple devices, and transfers status information concerning said job execution device's job processing status to the detected device via a network in case said detected device is different from said job execution device; and
the device detected by said detector transmits the status information to said portable terminal via said short-distance communication unit.

3. The status information notifying system according to the claim 2, wherein
said detector comprises:
a first detector that makes a judgment as to whether said job execution device is capable of conducting short-distance communication with said portable terminal and detects said job execution device as a device for communicating with said portable terminal via said short-distance communication unit in case it is judged said job execution device is capable of conducting short-distance communications with said portable terminal; and
a second detector that detects a device for communicating with said portable terminal via said short-distance communication unit from other devices in case it is judged said job execution device is not capable of conducting short-distance communication with said portable terminal.

4. The status information notifying system according to the claim 2, wherein said job execution device is equipped with an input device for designating said portable terminal, which is the notification target of the status information, from multiple portable terminals.

5. The status information notifying system according to the claim 2, wherein
said multiple devices include a job transmitting device that transmits the job to said job execution device;
said job transmitting device is equipped with an input device for designating said portable device, which is the notification target of the status information, from multiple portable terminals and transmits the portable terminal information of the designated notification target to said job execution device; and
said detector detects a device which is capable of conducting short-distance communication with said portable terminal, based on the portable terminal information received from said job execution device.

6. The status information notifying system according to the claim 2, wherein
the portable terminal information of the notification target is transmitted being attached to the job.

7. The status information notifying system according to the claim 2, wherein
said short-distance communication unit is a short-distance wireless communication unit for conducting short-distance wireless communication.

8. The status information notifying system according to the claim 2, wherein
said job execution device is an image forming device equipped with a printing unit for printing.

9. A status information notifying system comprising: a portable terminal; and multiple devices including a job execution device for executing a job and a communication device for communicating with said job execution device, at least one of which multiple devices is equipped with a short-distance communication unit for conducting short-distance communication with said portable terminal, wherein
said job execution device is equipped with a network interface for sending and receiving data via the network and transmits status information concerning said job execution device's job processing status to said communication device via said network interface;
said communication device is equipped with a detector for detecting a device that is capable of short-distance communication with the portable terminal from said multiple devices, and transfers status information concerning said job execution device's job processing status to the detected device via a network in case said detected device is different from said communication device; and
the device detected by said detector transmits the status information to said portable terminal via said short-distance communication unit.

10. The status information notifying system according to the claim 9 wherein said communication device is a job-transmitting device for transmitting the job to said job execution device.

11. A method of notifying status information concerning job-processing status to a portable terminal comprising steps of:
detecting, from multiple devices connected to a network, a device that is equipped with a short-distance communication unit for conducting short-distance communication with said portable terminal and is capable of conducting short-distance communication with said portable terminal;
transferring the status information to the detected device from a job execution device in case the detected device is not the job execution device; and
transmitting the status information to said portable terminal via said short-distance communication unit.

12. A device used for a status notifying system that notifies status information concerning job processing status to a portable terminal, comprising:
a network interface for sending and receiving data via a network;
a detector for detecting from multiple devices connected to the network a device that is capable of conducting short-distance communication with the portable terminal;
a short-distance communication unit for conducting short-distance communication with the portable terminal;
a first controller for controlling transmitting the status information to said portable terminal via said short-distance communication unit when the status information is received via said network interface from another device executing the job; and
a second controller for controlling transferring the status information to the device detected by said detector via said network interface and instructing transmission of the status information to said portable terminal, in case the job is executed by said device and said device is not capable of conducting short-distance communication with the portable terminal.

13. An image forming device comprising:
a print unit for executing a printing job;
a network interface for sending and receiving data via a network;
a detector for detecting from multiple devices connected to said network a device that is capable of short-distance communication with the portable terminal; and
a controller for controlling transmitting status information concerning printing job processing status to the detected device and instructing transmission of the status information to said portable terminal.

14. An image forming device comprising:
a print unit for executing printing job;
a network interface for sending and receiving data via a network;
a short-distance communication unit for conducting short-distance communication with a portable terminal; and
a controller for controlling receiving status information concerning printing job processing status and portable terminal information of notification target via the network interface, and transmitting the status information to the portable terminal via said short-distance communication unit.

15. A control program for an image forming device, wherein said program causing a computer to execute the steps of:
detecting a device that is capable of short-distance communication with a portable terminal from multiple devices connected to said network; and
transmitting status information concerning job processing status executed by said image forming device as well as portable terminal information of a notification target to the detected device and instructing it to transmit the status information to said portable terminal.

16. A control program for an image forming device, wherein said program causing a computer to execute the steps of:
receiving status information concerning job processing status from another device, which is connected to a network and executing a job, as well as portable terminal information of a notification target; and
transmitting the received status information to the portable terminal via a short-distance communication unit intended for conducting short-distance communication with the portable terminal.
